(19) United States
(12) Patent Application Publication
(10) Pub. No.: US 2013/0283154 A1
(43) Pub. Date: Oct. 24, 2013

(54) CONTENT DISPLAY SYSTEM

(71) Applicant: Panasonic Corporation, Osaka (JP)

(72) Inventor: Shuhei SASAKURA, Osaka (JP)

(21) Appl. No.: 13/919,493

(22) Filed: Jun. 17, 2013

Related U.S. Application Data
(63) Continuation of application No. PCT/JP2012/003851, filed on Jun. 13, 2012.

(30) Foreign Application Priority Data
Feb. 21, 2012 (JP) 2012-034613

(51) Int. Cl. G06F 17/21

(52) U.S. Cl. CPC G06F 17/212
USPC 715/253

(57) ABSTRACT

A content display system includes a client terminal for displaying contents and a server for managing the contents. The server manages a display layer associated with each page of main contents. The server creates a new page of the display layer based on predetermined rules and arranges on the new page of the display layer subcontents associated with the main contents, and sends to the client terminal the main contents and the display layer on which the subcontents are arranged. The client terminal displays the display layer on which the subcontents are arranged together with each page of the main contents with which the display layer is associated to associate the main contents and the subcontents with each other.

### CROSSREFERENCE TO RELATED APPLICATIONS

The present application is based upon and claims the benefit of priority of the prior Japanese Patent Application No. 2012-034613 filed on Feb. 21, 2012, and is a continuation of the International application No. PCT/JP2012/003851 filed on Jun. 13, 2012, the entire contents of which are incorporated herein by reference.

### BACKGROUND

1. Field

The present invention relates to configurations of communication methods and use of the communication methods pertaining to digital contents, such as communication methods using SNSs.

2. Description of Related Art

As a result of efforts to utilize relations among people around the world based on the statistical hypothesis “Six Degrees of Separation”, social networking services (hereinafter referred to as SNSs) came into being in the Internet, and they are in widespread used among the general public.

Patent Document 1 discloses a communication method using friendships through common contents, such as photos, text and the like. As a result of bringing human relations into networks, the method is in widespread use among the general public as a way for people to communicate with each other more closely. SNSs were materialized based on this invention as a basic patent.

Arranging comments vertically in order of priority is known as a display method used in SNSs. One example of priority is the time of posting. A viewer can grasp his or her friend's update status by reading their activities and comments arranged in chronological order. Patent Document 2 illustrates a way to create such a display method.

Although not relevant to SNSs, it is a popular face-to-face communication system among youths, according to Patent Document 3, to take photos with friends in a photo booth and decorate the photos with text, illustrations, etc. This is a widely popular way to affirm friendship between the subjects by writing messages and inscribing memories on the photos to visualize their relationship.

3. Prior Art Documents
Patent Document 1: U.S. Pat. No. 7,069,308
Patent Document 2: U.S. Pat. No. 7,669,123
Patent Document 3: Japanese Patent No. 3328679

Given that the display format as in Patent Document 1 or 2 is adopted to construct an SNS and users of the SNS communicate with each other on contents, the users need to explain in text as to which part of the contents his or her remarks are about. This is because these display methods basically do not take content communication into consideration. Achieving communication on contents as in the method described in Patent Document 3 may overcome such a problem.

However, if many posts are made on the same page (or scene) of the same contents as in SNSs, the posts overlap one another, thereby causing a decline in visibility. If the positions of the posts are changed to prevent the posts from overlapping one another, the pointing positions of the posts also change, so that it is difficult to understand the descriptions of the posts. Further, if the posts are configured to appear by blinking in order, it would be difficult for a user to read the posts at his or her pace.

### SUMMARY

The content display system disclosed in the present application is a content display system including a client terminal for displaying contents and a server for managing the contents. The server manages a display layer associated with each page of main contents. The server arranges subcontents associated with the main contents on the object layer. The server sends to the client terminal the main contents and the display layer on which the subcontents are arranged, and the client terminal displays each page of the main contains together with the display layer on which the subcontents associated with the main contents are arranged.

The content display system disclosed in the present application is a content display system including a client terminal for displaying contents and a server for managing the contents. The server sends to the client terminal main contents, subcontents associated with the main contents, and information on the arrangement of the subcontents. The client terminal manages a display layer associated with each page of the main contents. The client terminal arranges the subcontents associated with the main contents on the display layer based on the information on the arrangement of the subcontents, and the client terminal displays each page of the main contains together with the display layer on which the subcontents associated with the main contents are arranged.

### BRIEF DESCRIPTION OF THE DRAWINGS

FIG. 1 is a block diagram showing a configuration of a system according to Embodiment 1.

FIG. 2 is a block diagram showing the appearance of a typical electronic book reader terminal according to Embodiment 1.

FIG. 3 is a block diagram showing contents used in the typical electronic book reader terminal according to Embodiment 1.

FIG. 4 is a diagram showing a display not performed in the typical electronic book reader terminal according to Embodiment 1.

FIG. 5 is a diagram showing a communication method (one-to-one) according to Embodiment 1 through a server.

FIG. 6 is a screen image according to Embodiment 1.

FIG. 7 is a diagram showing a communication method (one-to-one) according to Embodiment 1 through the server.

FIG. 8 is a diagram showing an exemplary display where objects are arranged at different positions from their original positions.

FIG. 9 is a communication method (two-to-one) using the object arrangement portion according to Embodiment 1.

FIG. 10 is a diagram showing the structure of an object layer according to Embodiment 1.

FIG. 11 is a diagram showing a display not performed in the object layer according to Embodiment 1.

FIG. 12 is a flowchart of operations of the object arrangement portion according to Embodiment 1.

FIG. 13 is a diagram showing results of rendering performed by the object arrangement portion according to Embodiment 1.

FIG. 14 is a screen image where objects are arranged at different positions.

FIG. 15 is a diagram showing results of rendering objects A′ and C′ on the object layer according to Embodiment 1.

FIG. 16 is an image of the structure of the entire contents according to Embodiment 1.

FIG. 17 is a diagram showing variations of the display method and the structure according to Embodiment 1.

FIG. 18 is a diagram showing a variation of object overlapping determination according to Embodiment 1.

FIG. 19 is a flowchart of operations of the object arrangement portion according to Embodiment 1 in the case of objects A″ and C″.

FIG. 20 is a block diagram showing a configuration of a system according to Embodiment 2.

FIG. 21 is a block diagram showing a configuration of an information terminal 200 according to Embodiment 2.

FIG. 22 is a flowchart of operations of the information terminal 200 according to Embodiment 2.

FIG. 23 is a block diagram showing a configuration of a system according to Embodiment 3.

FIG. 24 is a diagram showing the structure of contents according to Embodiment 3.

FIG. 25 is a diagram showing a communication method according to Embodiment 3 through a server.

FIG. 26 is a flowchart of operations of a display arrangement portion 304 according to Embodiment 3.

FIG. 27 is a diagram showing the structure of a created object layer according to Embodiment 3.

FIG. 28 is a block diagram showing a configuration of a second system according to Embodiment 3.

FIG. 29 is a diagram showing a second communication method according Embodiment 3 through the server.

FIG. 30 is a flowchart of operations of the display arrangement portion 304 according to Embodiment 3 in consideration of activities.

FIG. 31 is a diagram showing the structure of an object layer according to Embodiment 3 in consideration of activities.

FIG. 32 is a diagram showing positions and priorities of objects according to Embodiment 4.

FIG. 33 is a flowchart of operations of an object arrangement portion 104 according to Embodiment 4.

FIG. 34 is a diagram showing results of rendering on an object layer according to Embodiment 4.

FIG. 35 is a diagram showing results of rendering on an object layer according to Embodiment 5.

### EMBODIMENTS

In an object display system disclosed in the present application, each page is provided with an area for posting comments and the area can be scrolled per display unit (page). At the time of scrolling, the object display system scrolls the area for posting comments at an integral multiple of the screen size in the scrolling direction. Of the area for posting comments, a portion having the same size as the screen is defined as one page, and comments are posted on the page. If there are already comments at the position where comments are to be posted, the comments are described in the next page. In there are no overlapping comments, the comments are described in the same page.

### Embodiment 1

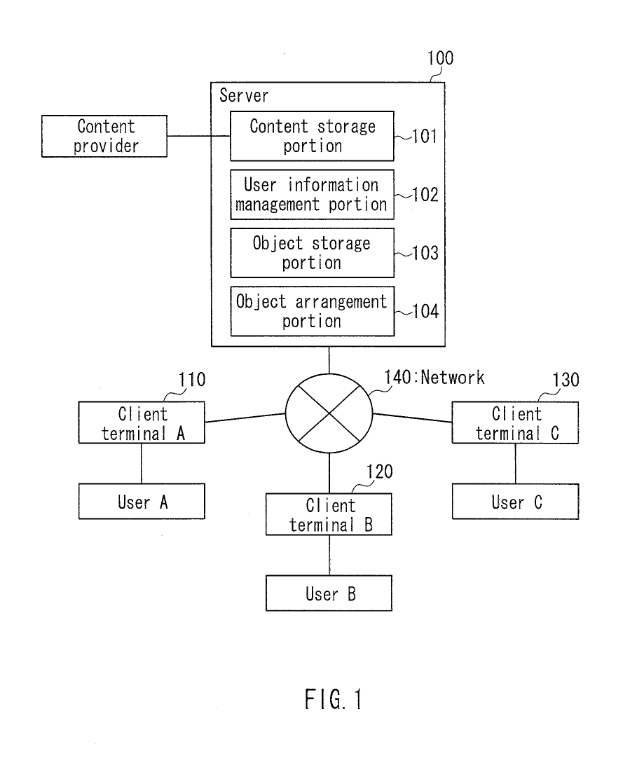

Hereinafter, a communication method according to the present embodiment will be described.

<FIG. 1: Configuration of SNS Using Contents>

FIG. 1 is a diagram showing a hardware configuration according to the present embodiment. The system includes a sever 100, client terminals A110, B120, and C130, and a network 140. Further, the server 100 includes a content storage portion 101, a user information management portion 102, an object storage portion 103, and an object arrangement portion 104. The functions of the user information management portion 102 and the object arrangement portion 104 are partially or entirely embodied by a processor, such as a CPU (central processing unit), included in the server 100 as a computing device executing predetermined programs. The functions of the content storage portion 101 and the object storage portion 103 are partially or entirely embodied by a storage device, such as a disk or memory, included in the server 100 as a computing device. Each of the client terminals also includes a processer such as a CPU and a storage device such as a disk or memory, as with the server 100.

In the present embodiment, it is assumed that the network 140 is the Internet. The server 100 is a server that provides services on the Internet, and the client terminals A110, B120, and C130 are terminals having access to the Internet. Although the present embodiment will be described by taking the Internet as an example of the network, other networks may also be used. The client terminals A110, B120, and C130 are connected to the server 100 through the network 140. In the strict sense, the client terminals are also connected to each other through the network 140. In the present embodiment, however, the clients do not have to have direct communication with each other, so that they only need to be capable of communicating with the server 100. In actual use, however, the clients may have direct communication with each other.

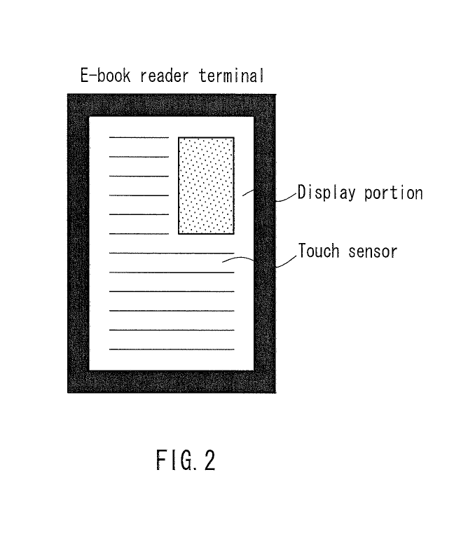

Through the content storage portion 101, the server 100 provides digital contents to be reproduced on the client terminals A110, B120 and C130. The digital contents include video, audio, web contents, etc., and the types of contents are not limited. The present embodiment will be described by taking electronic books as one example of the digital contents. The digital contents provided by content providers (in many cases, their producers and copyright holders) are stored in the server 100, distributed to each client terminal as needed, and browsed by users A, B and C of the respective client terminals.

<FIG. 2: Description>

For example, if the digital contents provided are electronic books, each client terminal works as an electronic book reader terminal. Hereinafter, a typically-used electronic book reader terminal will be explained with reference to FIG. 2. The electronic book reader terminal includes a display portion whose operating principle is based upon a liquid crystal display, an organic EL display, electronic paper, or the like, and electronic books can be displayed on the display portion. Further, a touch sensor is provided on the display portion, so that a user can operate (e.g., flick input operation) the electronic book reader terminal as if he or she is dealing with a paper book.

Next, the structure of a typical electronic book will be explained. In paper books, two or more pieces of paper are bound together at one of the four sides with glue, fastening hardware, cord, or the like. By turning pages about the bound side, text, images, and photos printed on each page can be browsed. Further, one side of a closed book is the front cover and the other side is the back cover. In many cases, page numbers are assigned to pages in order from the front cover to the back cover, and pages are read in numerical order. Books can be classified into two types, left bound and right bound, based on the bound side, i.e., whether they are right bound or left bound with respect to the cover (front cover). In particular, books with horizontal line orientations have a left bound structure and those with vertical line orientations have a right bound structure in many cases. The act of turning pages of paper books has been practiced by humankind through out a long history. Thus, the workings of books are readily understandable.

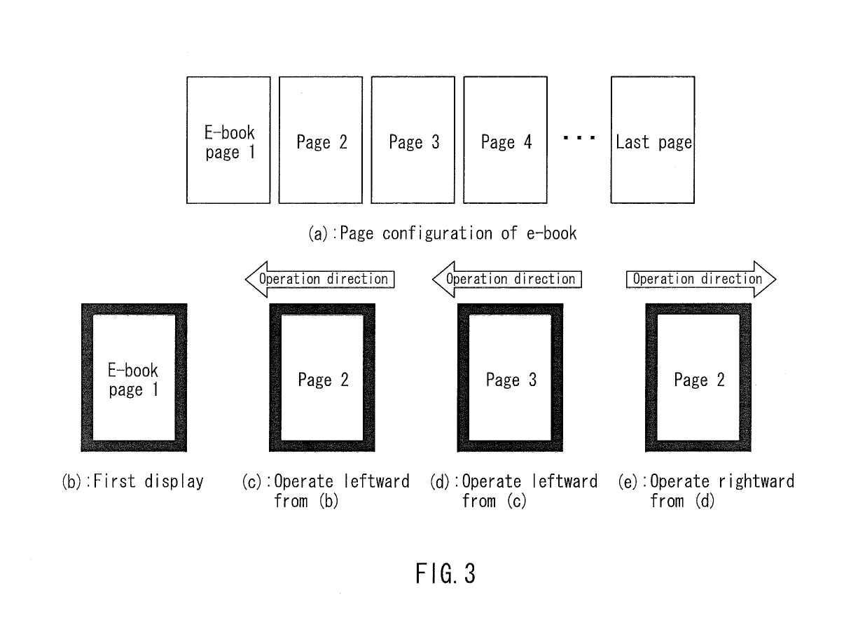

Electronic book reader terminals also provide workings similar to those of paper books through a touch sensor. In reality, the display portion of the electronic book reader terminal cannot be turned. Thus, in many cases, electronic books can be forwarded from one page to the next by swiping the screen with a finger. By replicating the way to handle paper books, electronic book reader terminals can be operated intuitively. Some electronic book reader terminals include switches or buttons around the display portion, and page turning is implemented through the switches or buttons. Some types of electronic book reader terminals display buttons on the display screen for page turning. What these electronic book reader terminals have in common is that pages can be turned just like paper books. Electronic books have no binding margin as they are in the form of electronic data. However, in order to make electronic books similar to paper books, they have fixed forward and back directions. Irrespective of the opening side, the direction 180° opposite to the forward direction is the back direction.

<FIG. 3: Description>

FIG. 3 shows an example of how to operate the typical electronic book reader terminal for page turning. FIG. 3(a) shows the structure of page data of electronic book contents used in the example of operating the typical electronic book reader terminal for page turning. In the diagram, page 1 (front cover), page 2, page 3, page 4 and the last page are shown in series from the left side (intermediate pages are not shown). Pages between page 4 and the last page are not shown in the diagram but they do exist in reality. Although page contains text, images, photos, etc., only page numbers are shown in order to facilitate understanding of the workings. It should be noted that this does not intend to limit the actual contents of each page.

FIG. 3(b) shows a state in which an electronic book whose data is aligned as in the structure shown in FIG. 3(a) is opened on the electronic book reader terminal. The electronic book reader terminal shown in FIG. 3(b) is displaying page 1 as the first page shown in FIG. 3(a). FIG. 3(c) shows a screen transition caused by operating the touch sensor leftward (e.g., flick input operation) in the display state of FIG. 3(b). In FIG. 3(c), page 2 of FIG. 3(a) is displayed, and page 1 of FIG. 3(b) is no longer displayed.

FIG. 3(d) shows a screen transition caused by operating the touch sensor leftward in the state of FIG. 3(c). In FIG. 3(d), page 3 in FIG. 3(a) is displayed, and page 2 in FIG. 3(c) is no longer displayed. In this way, the pages of the electronic book data shown in FIG. 3(a) can be forwarded by operating the touch sensor leftward. Further, FIG. 3(e) shows a screen transition caused by operating the touch sensor rightward in the state of FIG. 3(d). In FIG. 3(e), not page 4 but page 2 in FIG. 3(a) is displayed. Also, page 3 displayed in FIG. 3(d) is not displayed. While the touch sensor is operated leftward until FIG. 3(d), the touch sensor is operated rightward in FIG. 3(e), so that the page transition is in the back direction, and not page 4 as the next page but page 2 is displayed as a result. Pages can be transitioned by performing operations similar to turning pages of paper books.

In FIG. 3, the book is configured such that pages are forwarded from left to right as in FIG. 3(a). Conversely, when the book is configured such that pages are forwarded from right to left, the touch sensor may be operated rightward to forward one page to the next, and leftward to go back to the previous page. Further, if electronic book data only contains data of text, images and layout of each page and does not contain information on operation directions of pages, the electronic book reader terminal may be operated based on operation directions and page transition directions that are associated with each other through an application installed in the electronic book terminal.

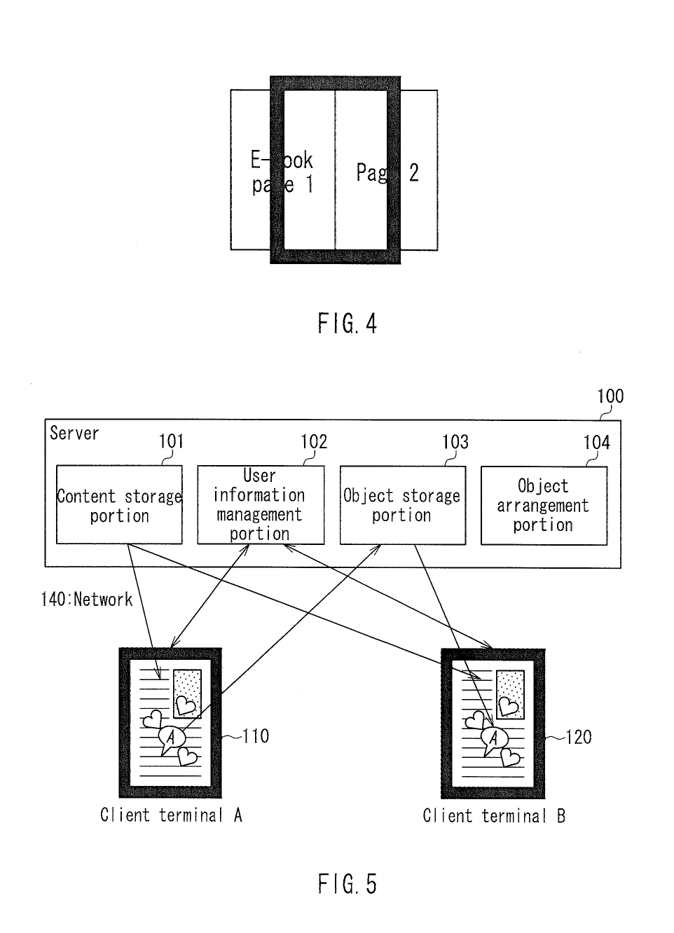

In the operation example described with reference to FIG. 3, the electronic book reader terminal provided with a touch sensor is used as an example. It is also possible to control pages in the forward/back directions through switches provided outside the display portion or switches displayed on the screen.

<FIG. 4: Description>

Features of the display performed in FIG. 3 will be described with reference to FIG. 4. FIG. 4 shows an example where the terminal opening the electronic book data of FIG. 3(a) is being operated leftward from the state of FIG. 3(b). In comparison to FIG. 3(c) showing the same state, page 2 is displayed but page 1 is not displayed in FIG. 3(c). In FIG. 4, however, the right side of page 1 is displayed on the left half of the display portion and the left side of page 2 is displayed on the right half. In the case of electronic books, generally, pages do not become misaligned. The display as in FIG. 4 occurs because original paper books have a page concept. Electronic book reader terminals display electronic books page by page.

Depending on the electronic book terminals and the format of electronic books, the number of pages can be increased or decreased by actively changing the amount of information to be displayed within a single page through the text size and the display portion, so that there may be a unit concept other than page. Even still, given that a range that stays within one screen is a page, screens can be switched to display the next or previous page by operation.

Although it has been stated that pages do not become misaligned as in FIG. 4, they may be displayed in a misaligned state as animation during a transition from FIGS. 3(b) to 3(c) by the user operation. This is effective means to let the user know that the page will be changed following the user operation.

It is assumed that when displaying only electronic book contents the client terminals A110, B120, and C130 of FIG. 1 used in the present embodiment display in the same manner as the preexisting electronic book reader terminal explained with reference to FIGS. 2, 3, and 4.

The user information management portion 102 and the object storage portion 103 of FIG. 1 have functions related to an SNS. The right to access the server 100, personal information on each user, information on a client terminal owned by each user, friendship of users, etc., are stored in and managed by the user information management portion 102. For example, generally, different devices, for example, a database and a management portion, may be used to define a functional part for recording and holding each information data and a functional part for combining, adding, rewriting and deleting the information data, respectively. However, since there is no need to separate both functional parts in the present embodiment, the both functional parts are combined into the user information management portion 102.

The object storage portion 103 is a portion in which posts made by each user are stored. The object storage portion 103 is a block serving as the mainstay of communication through an SNS. Text, images, photos, etc., posted by each user are stored in the object storage portion 103. The object storage portion 103 also can provide text, images, photos, etc., in accordance with user requests.

In the present embodiment, users communicate with each other on contents (electronic book) through an SNS. A way in which users A and B communicate with each other in the system configuration of FIG. 1 will be described. In the present embodiment, users using an SNS communicate with each other not on web pages but on pages of an electronic book.

<FIG. 5: Description>

An example of the workings of how the client terminals A110 and B120 communicate with each other through the server 100 will be described with reference to FIG. 5.

The content storage portion 101 provides electronic book contents to the client terminals A110 and B120. In the present embodiment, both the contents and the SNS are provided by a single server. However, when there is a means for providing the contents, the contents and the SNS may be provided by different servers because in actual service electronic books (contents) and SNSs are provided separately by publishers and service providers.

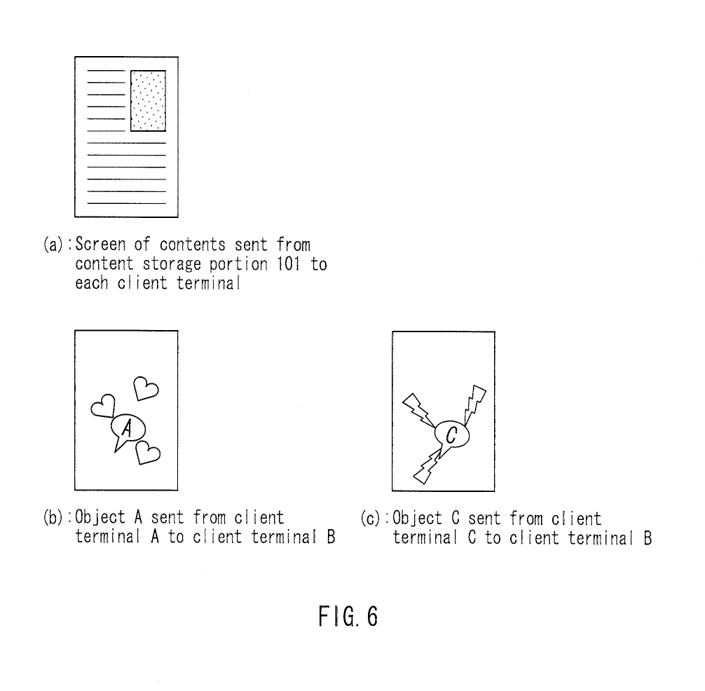

The contents provided by the content storage portion 101 are shown on the displays of the client terminals A110 and B120. The user A as the owner of the client terminal A110 and the user B as the owner of the client terminal B120 can browse the displayed contents on the respective client terminals. As a result, settings in which the users A and B can browse the same contents are established.

<FIG. 6: Description>

FIG. 6(a) shows a screen image of contents that can be browsed at this time. The screen image is of one of the pages of an electronic book.

As a result of the same contents being displayed and each user being able to read the descriptions, there arises a reason for them to communicate with each other. Thus, the users can communicate with each other on the contents. User information for allowing communication is stored in the user information management portion 102. That is, user registrations to the SNS site, user IDs, login passwords, the relationship between the users A and B, and the like are stored in the user information management portion 102. By making full use of these pieces of information, a smooth communication service can be implemented.

The user A has made a post as shown in FIG. 6(b) on the client terminal A110. The post at this time may be, for example, text, a decorated image as in the prior art document, a photo, video, or the like. Hereinafter, they will be referred to as objects. Further, given that the contents on which the objects are posted are main contents, the objects can be referred to as subcontents.

The object posted by the user A will be referred to as the object A, as it was posted by the user A in particular. When the object A of FIG. 6(b) is rendered on the screen of FIG. 6(a), the image as shown on the display of the client terminal A or the client terminal B of FIG. 5 is obtained. The object A is particularly in the form of a balloon, and points a certain position in the screen of FIG. 6(a), so that it is an object whose position information has importance.

The object A, and information on the content and position of which the post is directed, and by whom the post is made, and the intended recipient of the post are stored in the object storage portion 103. The time at which the post is made is also stored.

The object A stored in the object storage portion 103 is sent to the client terminal B120. The timing at which the object A is sent to the client terminal B120 is when the user B opens the page shown in FIG. 6(a) on the client terminal B120 and reads the posted comments. The object A can be sent prior to that and may be cached in the client terminal B120.

On the display of the client terminal B120, the comments posted by the user as shown in FIG. 6(b) are displayed together with the screen of FIG. 6(a). This screen is the same as that appearing on the display of the user A's client terminal A110, and the object A is reproduced at the same position as in the client terminal A110, which reflects the user A's intention. As a result, the users A and B can communicate with each other through their screens.

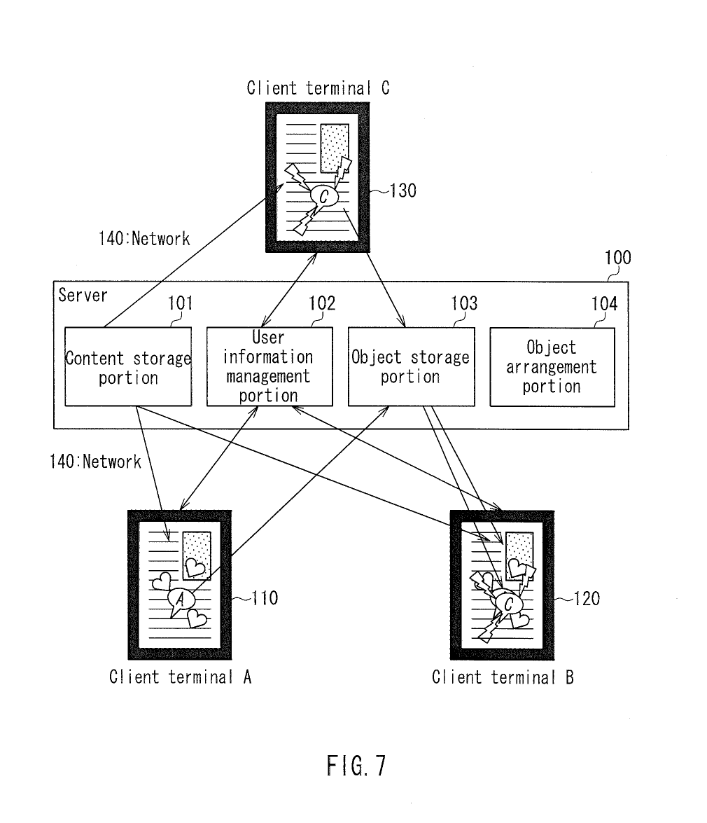

FIG. 7 shows a case where the client terminal C130 (which is not shown in FIG. 5) is added to the state of FIG. 5. The configuration shown in FIG. 7 includes the client terminals A110, B120, and C130, in addition to the server 100, and the client terminals are connected to each other through the server 100. This configuration is the same as that of FIG. 1. The content storage portion 101 has the same roles as those explained with reference to FIG. 5, and provides contents to each client terminal. The display screen of the contents provided is shown in FIG. 6(a), which is the same as that used in explaining FIG. 5.

As in FIGS. 1 and 5, the user information management portion 102 of FIG. 7 bears information necessary for carrying out communication smoothly through an SNS. This time, the information further includes information on the user C as the owner of the client terminal C130, but the roles of the user information management portion 102 are not changed.

Here, it is assumed that the user C makes a post as shown in FIG. 6(c) on the client terminal C130, for example. This post is also an object. However, this post is a different object from the object A posted by the user of the client terminal A110. In order to distinguish one object from another, the object representing this post will be referred to as the object C. The object C rendered on the client terminal C130 is displayed together with the content image of FIG. 6(a). The displayed screen is as on the display of the client terminal C130 of FIG. 7, for example.

This new object C is sent to the object storage portion 103. In this case, information on the content and position to which the post is directed, by whom the post is made, and the intended recipient of the post is stored in the object storage portion 103. At this time, the position in the contents at which the object C is posted is the same as the position in the contents at which the object A (the object directed to the user B from the user A) is posted as explained with reference to FIG. 5. The object C is directed to the user B from the user C, and the time of post of the object C is later than the time of post of the object A from the user A to the user B. Thus, the time of post of the object C additionally is recorded.

<FIG. 7: Description>

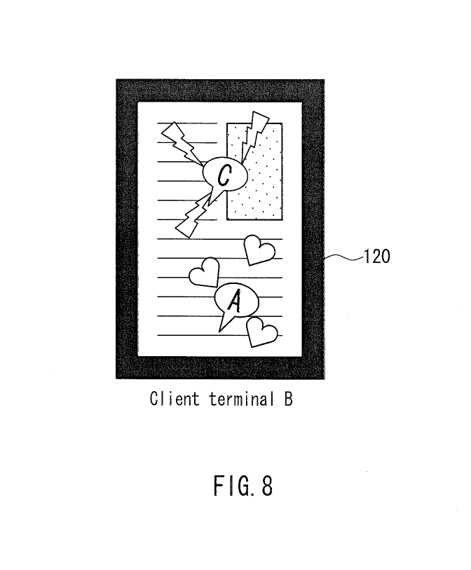

The object C posted by the user C and stored in the object storage portion 103 is sent to the client terminal B. In the client terminal B120, the object C is displayed on the same page of the same contents as the object A. However, since the client terminal B120 has already received the object A from the client terminal A110, the object C overlaps with the object A. This makes it difficult to understand the descriptions of the object A. The display of the client terminal B120 of FIG. 7 shows an example where the object C created by the user C overlaps with the object A created by the user A.

<FIG. 8: Description>

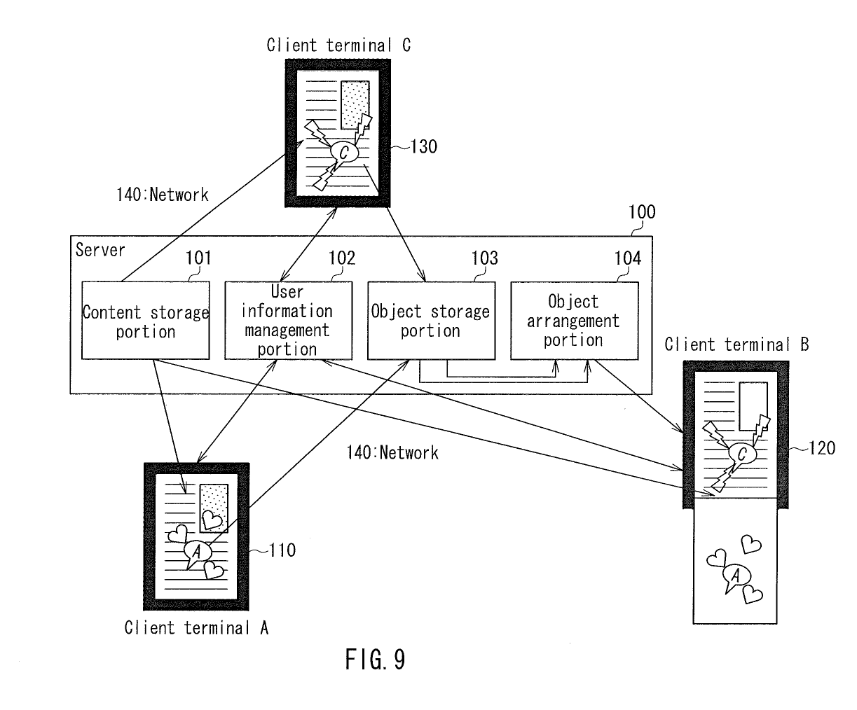

FIG. 8 shows an example in which the objects are displayed after changing their positions. FIG. 8 shows the objects A and C on the same page of the same contents. In order to prevent the objects from overlapping one another, each object is moved to a different position on the screen, and is displayed in a reduced scale. As a result, the both objects are shown on the display. However, the pointing position of the balloon of each object has been changed, so that what is intended by the user who posted the object cannot be notified. As an example other than arrows, if an important image is enclosed with a red circle but the circle deviates from its original position, the information of the circle is meaningless. That is, a problem specific to communication on a page arises, which communication is more flexible than communication only in text.

<FIG. 9: Description>

In order to solve the above problem, the server 100 includes the object arrangement portion 104. A communication method using the object arrangement portion 104 will be described with reference to FIG. 9. In the state shown in FIG. 9, it is assumed, as in FIG. 7, that the client terminals A110, B120, and C130 are connected to each other through an SNS provided by the server 100, and the object A of FIG. 6(b) posted by the user A is sent from the client terminal A110 to the client terminal B120 through the server 100, and the object C of FIG. 6(c) created by the user C is sent from the client terminal C130 to the client terminal B120 through the server 100.

The transmission method of FIG. 9 is different from that of FIG. 7 in that the objects are not sent directly from the object storage portion 103 to the client terminal B120 but are sent from the object storage portion 103 to the object arrangement portion 104 and then to the client terminal B120.

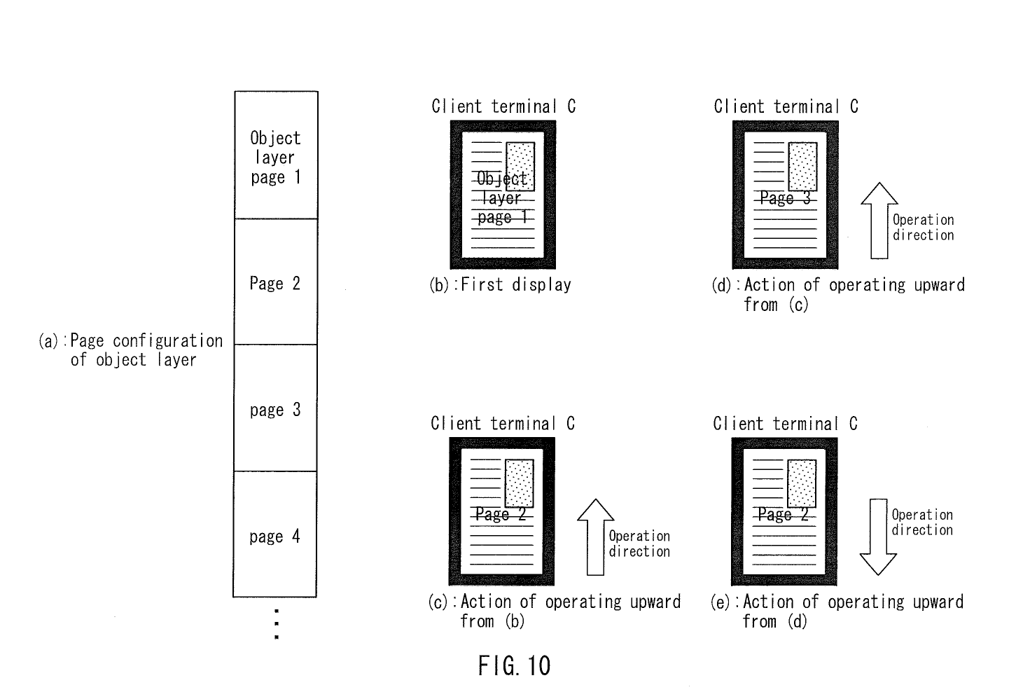

The states shown in FIGS. 7 and 9 differ in how the sent object data is handled. On the display of the client terminal 9 of FIG. 9, the object C posted by the user C is displayed together with the contents of FIG. 6(a), and the object A posted by the user A is provided on a page outside the display. In this case, the object C is arranged at the proper content position and the object A is arranged outside the screen displaying the contents.

<FIG. 10: Description>

Hereinafter, a method for arranging objects generated by the display arrangement portion 104 of FIG. 9 and a method for displaying the objects received by the client terminals will be described with reference to FIG. 10. It is assumed that the objects outputted from the object arrangement portion 104 are configured to have a plurality of display layers. For example, it can be said that there are layers for each certain page of an electronic book, and the objects are superimposed thereon. However, the object display layers do not overlap one another and they exist at the same level. FIG. 10(a) is a diagram showing the structure of object layers (display layers) as the layers for displaying the objects. For example, the base of the object layers is transparent or semi-transparent. Thus, when the object layers are superimposed on contents, it can be seen that objects are displayed above the contents. The object layer has such a structure that it is divided into pages and the pages are connected to each other in order (e.g., a row structure). A row of object layer is present per the display unit (here page) of the electronic book. The pages of the object layer have the same size as the display unit (here page) of the electronic book. Although comments, images, and photos posted by each user will be arranged on the object layer, only page numbers are shown in the figure in order to make it easier to distinguish one page from another.

A method for operating the object layer will be described with reference to FIGS. 10(b) to 10(e). FIG. 10(b) shows the beginning of the object layer for a certain page of an electronic book. In FIG. 10(b), page 1 of the object layer shown in FIG. 10(a) at the top is shown. The content screen of FIG. 6(a) is used as the page of the electronic book displayed in FIG. 10(a).

FIG. 10(c) shows operation results of operating the touch sensor of the client terminal upward from the display state of FIG. 10(b). In FIG. 10(c), page 2 of the object layer of FIG. 10(a) is shown. As a result of operating the touch sensor upward, the object layer of FIG. 10(a) has moved only by one screen, and page 2 of the object layer thus is shown. At this time, the content page of the electronic book is not changed. This is because the content page controlling method and the object layer page controlling method are different from each other. As explained above with reference to FIG. 3, the touch sensor is operated in the lateral direction to turn pages of the electronic book. Therefore, the vertical operation is unassigned. Thus, by assigning the vertical operation to the object layer, the object layer can be controlled separately from turning pages.

FIG. 10(d) shows operation results of operating the touch sensor further upward continuously from the display state of FIG. 10(c). In FIG. 10(d), the content layout of the displayed electronic book remains unchanged from FIG. 6(a) and only the object layer has changed, so that page 3 in FIG. 10(a) is shown. This is because the touch sensor was not operated in the lateral direction to control content pages but was operated in the upward direction to control the object layer as in FIG. 10(c). Thus, the layout screen of the contents remains unchanged and only the object layer has moved to the next page.

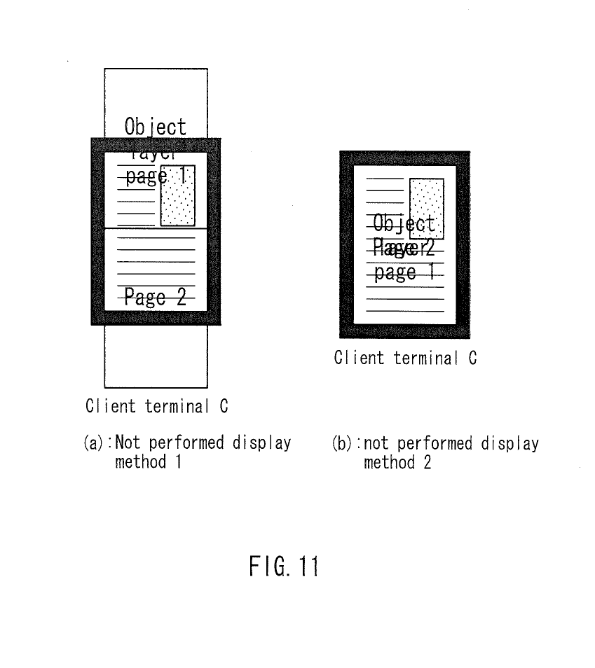

FIG. 10(e) shows operation results of operating the touch sensor downward continuously from the display state of FIG. 10(d). In FIG. 10(e), the content layout of the displayed electronic book remains unchanged from FIG. 6(a) and only the object layer has changed. Further, while the next page of the object layer is shown in FIGS. 10(c) and 10(d), page 2 as the previous page of the object layer is shown in FIG. 10(e). This is because the touch sensor is operated differently. While the touch sensor is operated upward in FIGS. 10(c) and 10(d), the touch sensor is operated downward in FIG. 10(e). The object layer can be controlled in a manner similar to controlling the electronic book, but the unassigned vertical operation is used in contrast with the way to control the electronic book. Thus, as a result of operating the touch sensor downward, the object layer has returned by one page.

<FIG. 11: Description>

The features of the display performed in FIG. 10 will be described with reference to FIG. 11. FIG. 11(a) shows a case where the touch sensor is operated upward in the state of FIG. 10(b). In comparison with FIG. 10(c) showing the same state, while page 2 of the object layer is completely shown and page 1 is not shown in FIG. 10(c), page 1 is shown in the upper half and page 2 is shown in the lower half of FIG. 11(a). However, the state in which both pages of the object layer are shown does not occur. This is because objects to be rendered on the object layer have position information. If they are displayed at deviated positions, a difference between the content layout below the object layer and the display position of the object arises, so that the position information becomes faulty. It is described that the object layer is not displayed as in FIG. 11(a) but it may be used as animation during transition from FIG. 10(b) to FIG. 10(c) by the user operation. This can be effective to let a user know visually that page will be turned in accordance with his or her operation.

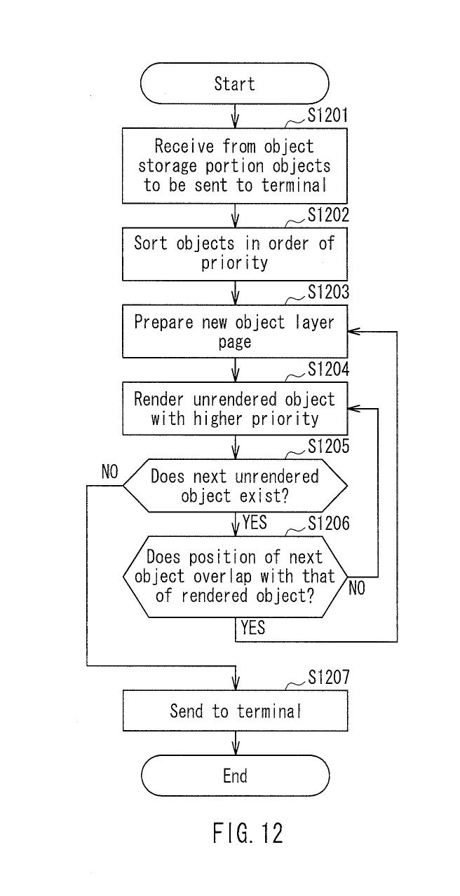

Further, two or more pages of the object layer are not displayed together as in FIG. 11(b). This is because if two or more pages of the object layer are displayed together, conflicts occur among objects, making the visual identification of objects difficult. However, this also may be used as animation during screen transition.

<FIG. 12: Description>

FIG. 12 is a flow chart showing how the object arrangement portion 104, whose configuration and roles are the same as those in FIG. 9, generates an object layer. First, the object arrangement portion 104 receives from the object storage portion 103 an object(s) to be sent to the user B-owned client terminal B120 (step S1201). Here, it is assumed that there are two or more objects to be sent. If there is only one object to be sent, the object arrangement portion 104 simply needs to output the only object.

Next, the object arrangement portion 104 sorts the received objects in order of priority (step S1202). Here, the order is determined based on which object needs to be shown to the user B the most. In many cases, the objects are sorted in order based on the time of creation (the time at which comments are posted by each user), which is also used in Patent Document 2. When an additional object is created for an object (e.g., reply comments to comments posted by each user), the objects including the original object may be sorted in order based on the time at which the additional object is created. The order may be determined using an SNS function, such as “Likes” from other users. For example, a higher priority may be given to comments that received many Likes from other users. U.S. Pat. No. 7,788,260, for example, describes in detail text prioritization using the Like function (use of the like function in the context of searching), so that description thereof will not be repeated herein. Further, certain keywords, text, etc., contained in comments may be used to set the priority. For example, a higher priority may be given to comments containing a recipient name, certain keywords, or the like and a lower priority may be given to advertisement and solicitation mails such as spam mails. Further, certain keywords can be extracted from SNS user information or user log information. The reference history of a user him or herself or those of other users may be used as a criterion because comments that are referenced many times may be attracting a lot of attention, for example. Here, whether or not the objects already have been visually identified may be determined based on whether the objects have been displayed on each user's client terminal or not. Further, the determination may be made by using these priority determining methods in combination. In the example of FIG. 9, the date and time of creation of objects are used as the criterion. The newer the date and time of creation, the higher the priority is. In the example, the object A is created by the client terminal A110 first and then the object C is created by the client terminal C130. Thus, the object C has a higher priority than the object A. Note that the information used in determining the object priorities is stored in the object storage portion 103, and the object arrangement portion 104 also receives the information at step S1201 together with the objects.

After determining the object priorities, an object layer is created for displaying the objects in order of priority. First, since there is no object layer, the first page of the object layer is prepared (step S1203). At this point, page 2 and later do not exist.

On the prepared object layer (on 1 page out of 1 page), one with the highest priority of the unrendered objects is rendered (step S1204). The priorities have already been determined at step S1202, and the unrendered object with the highest priority is the object C. Thus, the object C is rendered on page 1 of the object layer.

Next, the process branches at step S1205 based on whether or not any unrendered object still remains (step S1205). There are two objects in FIG. 9, and the only object that already has been rendered is the object C, which has a higher priority than the object A. Thus, the object A whose priority is lower than the object C is not rendered yet. Consequently, YES is selected because the object A still remains unrendered, and the process advances to step S1206 as the next decision branching point.

At step S1206 as the next decision branching point, whether or not the rendering positions of the rendered object and one with the highest priority of the unrendered objects will overlap one other is determined (step S1206). Here, the rendered object is the object rendered on the last page of the object layer. At this point, the object layer only has one page and the object C is arranged on page 1. As in the display portion of the client terminal of FIG. 7, the objects A and C are at overlapping positions, so that this situation corresponds to YES at step S1206. Thus, step S1203 is implemented.

At step S1203 for the second time, page 2 of the object layer is created in order to create a new page of the object layer, and the object will be arranged on page 2 thereafter. At this point, the creation of page 1 has been completed.

At the subsequent step S1204, the unrendered objects with the highest priority is arranged on the newly created page 2 of the object layer. At this point, the unrendered object is the object A. Thus, the object A is rendered on page 2.

After finished rendering the object A on page 2, no unrendered object remains at the point of step S1205. Thus, at step S1205 for the second time, the process takes the NO route.

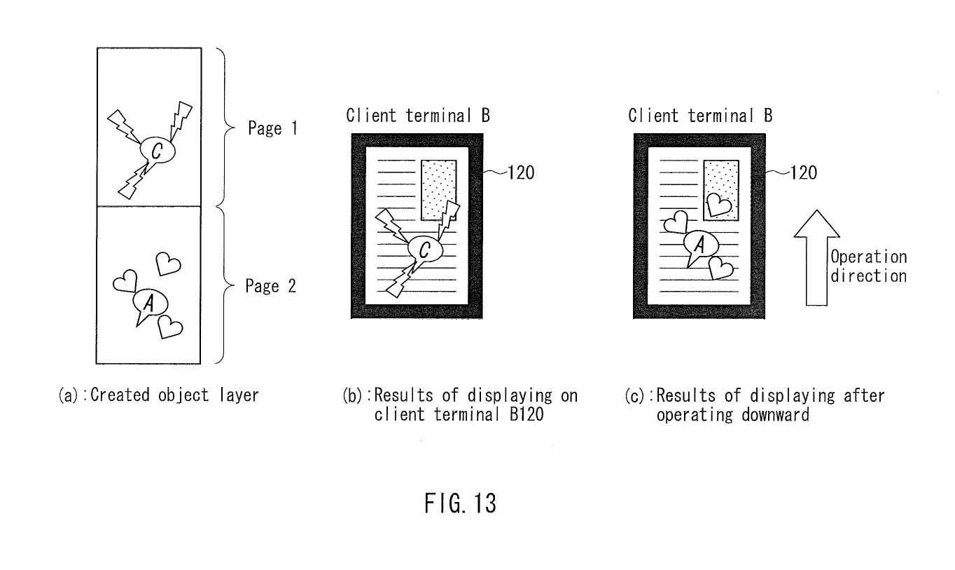

The arrangement of all of the objects on the object layer is completed as a result of the above process, so that the finished object layer is sent to the display terminal (step S1207). Here, the display terminal is the client terminal B120.

<FIG. 13: Description>

FIG. 13(a) shows the configuration of the created object layer as of the end of the flow of FIG. 12. The object layer has two pages: the object C shown in FIG. 6(c) has been rendered on page 1, and the object A shown in FIG. 6(b) has been rendered on page 2.

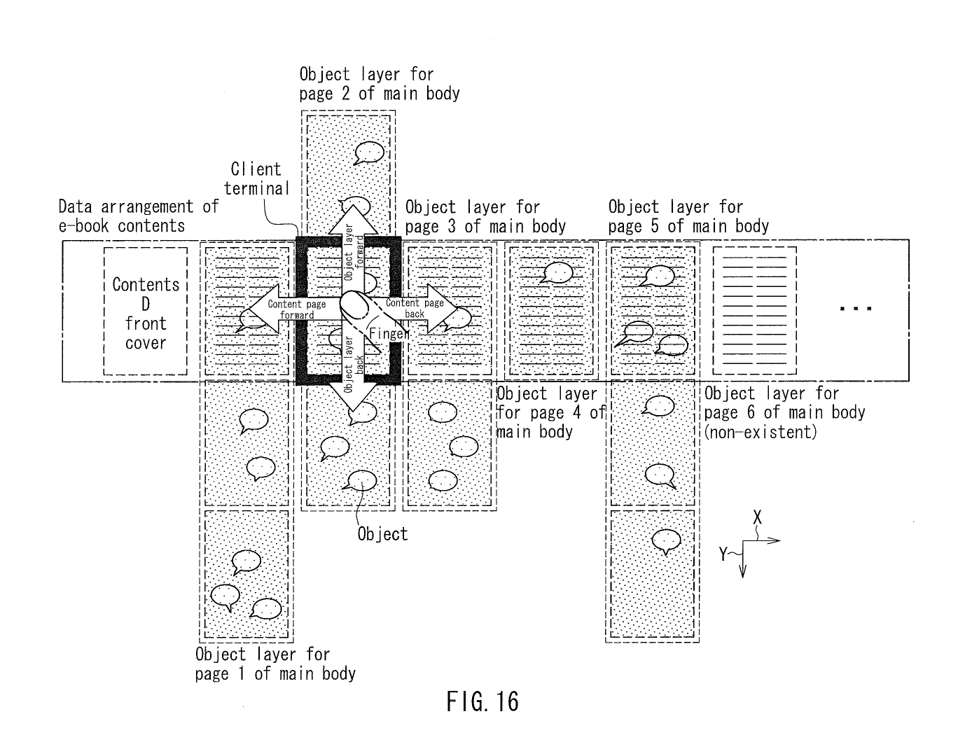

FIG. 13(b) shows a case where the object layer of FIG. 13(a) is displayed on the client terminal B120. Since the process is in accordance with FIG. 9, the displayed electronic book contents are the same as those shown in FIG. 16(a). Page 1 of the object layer is displayed above the contents. In this state, the user B as the user of the client terminal B120 can read the user C-created object C rendered above the contents. The arrangement position of the object is the same as the position at which the object C was created by the user C, meaning that the object having a positional meaning is displayed and rendered properly. This is because the size of the object layer page is in line with the size of the content page, as described above.

FIG. 13(c) shows the screen after operating the touch sensor of the client terminal B120 upward from the state of FIG. 13(b). Page 1 of the object layer of FIG. 13(a) shown in the state of FIG. 13(b) is no longer shown, and page 2 is shown. The workings are the same as those explained with reference to FIG. 10. As a result, the user B can read the object A created by the user A. The arrangement position of the object is the same as the position at which the object was created by the user A, meaning that the object having a positional meaning is displayed and rendered properly.

No explanation has been made so far as to the branching process when “NO” is selected at step S1206 in FIG. 12. Hereinafter, an example of choosing this alternative will be described.

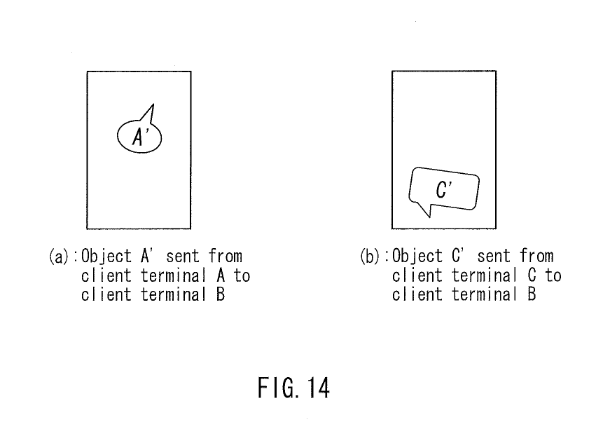

The server 100 and the client terminals A110, B120 and C130 have the same configurations and relations as those in FIG. 9. In the above, the object created on the client terminal A110 has been referred to as the object A (FIG. 6(b)) and the object created on the client terminal C120 has been referred to as the object C (FIG. 6(c)). In this example, however, changes are made to the objects A and C. The changed objects are shown in FIG. 14. FIG. 14(a) shows an object created on the client terminal A110. In this example, the object will be referred to as an object A′. Further, FIG. 14(b) shows an object created on the client terminal C130, and the object will be referred to as an object C′. The difference between the objects A and C and A′ and C′ is that while the objects A and C are arranged at overlapping positions in the previous example, the object A′ is arranged in the upper part and the object C′ is arranged in the lower part of the area, so that they do not overlap one another. The operations of the object arrangement portion 104 for sending the objects A′ and C′ to the client terminal B120 in the configuration of FIG. 9 will be described with reference to the flow shown in FIG. 12.

<FIG. 9: Second Description>

At step S1201, the object arrangement portion 104 receives from the object storage portion 103 the information used in determining the priorities of the objects A′ and C′ (here, the date and time of creation of the objects).

Next, at step S1202, the objects are sorted in order of priority. The object C′ carries a higher priority than the object A.

Next, at step S1203, a new object layer is created. At this point, the object layer only has one page.

At step S1204, the unrendered object with the highest priority is rendered on the object layer. First, the object C′ is rendered.

At step S1205, whether or not any unrendered object still remains is determined. Since the object A′ has not been rendered in this state, YES is selected and the process advances to step S1206. The flow up to this point is the same as that explained in the previous example.

At step S1206, whether or not the rendering positions of the rendered object and the unrendered objects with the highest priority will overlap one another is determined. The only object already rendered on the last page is the object C′ and the unrendered object is the object A. Thus, these two objects are compared with each other. As a result, they are determined as not overlapping one another. Thus, NO is selected at step S1206.

When the objects do not overlap one another, no new object layer page is created, and the unrendered object will be rendered on the current object layer at step S1204. As a result, the unrendered object A′ is rendered on page 1 of the object layer.

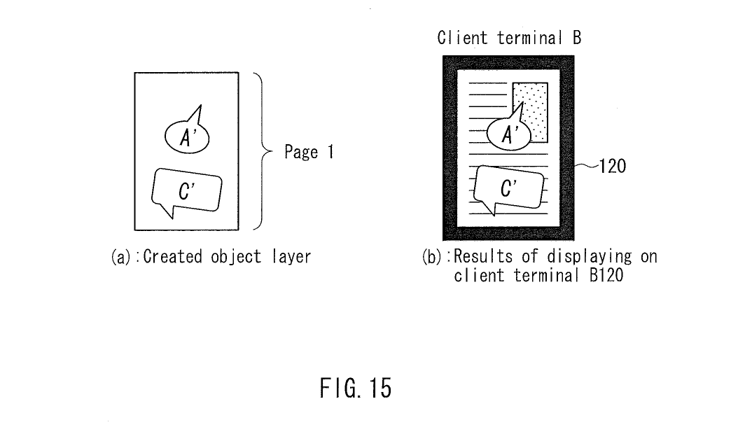

Next, since there is no more unrendered object left, NO is selected at step S1205, and the object layer is sent from the server to the client terminal B120 at step S1207.

<FIG. 15: Description>

Here, FIG. 15 shows the sent object layer and an exemplary screen displayed on the client terminal B120.

FIG. 15(a) shows the structure of the object layer created by the object arrangement portion 104. Unlike in FIG. 15(a), the object layer does not have two or more pages and both the objects A′ and C′ have been rendered on a single page.

FIG. 15(b) shows a case where the object layer created as above is displayed on the client terminal B120. Since the objects do not overlap one another, each object can be read without any trouble. When there is no need to turn pages as in this case, no additional page is created. Thus, unlike in FIG. 13, no object layer page needs to be controlled.

Although three users, three client terminals, and two objects are used in the description of the present example, a network of several ten thousands to several ten million users can be expected in actual service. Therefore, a great many number of objects are stored in the server, and users read them as needed. If two or more objects cannot be arranged within one object layer page, as many object layer pages as objects are needed. In this case, the number of times the object layer needs to be operated vertically increases, which makes the operation burdensome. In contrast, by rendering two or more objects in a single page when they do not overlap one another and can be visually indentified and displaying them in different pages when they cannot be visually identified, a display method having both visibility and operability can be achieved.

<FIG. 16: Description>

Although one screen shown in FIG. 6(a) is used to describe the configuration of FIG. 1, actual electronic book contents spread over two or more pages and the object layers are provided independently for each of the pages. FIG. 16 shows an exemplary conceptual diagram of the actual structure.

FIG. 16 shows a state in which an object layer is provided for each data page of electronic book contents (provisionally being named content D). Content pages are arranged in a lateral direction (arrow X direction) and object layer pages are arranged in a vertical direction (arrow Y direction) of each page. Given that the terminal can be operated in lateral and vertical directions, the content pages can be turned by operating the terminal in the lateral direction and the object layer pages can be turned by operating the terminal in the vertical direction.

The length (number of pages) of the object layer that belongs to content pages varies depending on object overlaps and thus on the content pages. No object layer or an empty object layer is provided for an unoccupied content page. As a result, both the electronic book contents and the object layers with comments can be seen, so that an SNS having a communication function through contents can be created.

<Relationship Between Contents and Object Layer in Size>

Since an object layer is provided for each content page, and object layer pages are switched back and forth based on designated positions in the content pages, it is preferable that each content page and each object layer page have the same size. Further, to show an animated scroll representation when scrolling the object layer, a margin may be secured between object layer pages. In this case, however, the object layer needs to be scrolled additionally by the same amount as the width of the margin, and the area including no margin (only object layer page) needs to be displayed when the animated scroll representation ends. Further, the margin may be a line (e.g., a broken line) indicating the boundary between object layer pages. By securing a margin, the visibility of the object layer pages can be improved.

### Modified Example

In the present embodiment, electronic book reader terminals are taken as an example of the user client terminals but the terminals are not limited to electronic book readers and the client terminals may be terminals such as portable phones, smart phones, tablets, notebook PCs, and PDAs. Further, the client terminals may be terminals such as large display devices like televisions, which can be controlled using remote controllers and hand gestures without directly touching the terminals. Further, although the operations through the touch screen have been described, the terminals may be provided with control buttons such as a cross button. The types of information terminal and input means are not limited.

In the present embodiment, electronic books are used as an example of contents. However, the contents may be in the form of electronic magazines, newspaper, or the like. The types of contents are not limited as long as the contents are in electronic form and can be reproduced on information terminals (here, client terminals).

In the present embodiment, the method for controlling electronic book contents has been described in which that the pages can be forwarded by operating the touch sensor leftward and the pages can be turned back by operating the touch sensor rightward, so that the users can have the same experience as reading a left bound paper book. However, there are also many right bound books. In this case, the right and left may be reversed.

In the present embodiment, it has been described that the touch sensor is operated in the lateral direction to control the electronic book contents and is operated in the vertical direction to control the object layer. The reason for this that a book bound in the lateral direction (i.e., having either a left or right bound structure) is taken as an example. As another example, electronic books having a top or bottom bound structure may also be used. In this case, the touch sensor may be operated in the vertical direction to control the electronic book contents and be operated in the lateral direction to control the object layer.

In the present embodiment, it has been described that the method for controlling an electronic book is determined based on whether the book in the paper edition is left bound or right bound. However, the control method can be set through user settings or set dynamically based on user habits. Similarly, a user may set the direction used in controlling the object layer. Further, the control directions do not have to be a linear direction and may be a circular direction, for example.

In the present embodiment, it has been described that the object layer is forwarded to the next page when the touch sensor is operated downward and goes back to the previous page when the touch sensor is operated upward. This is because an object with a higher priority is arranged at the top and that with a lower priority is arranged at the bottom as an example. Conversely, there are also many methods used in the Internet that show new comments at the bottom. In this case, pages in order of priority may be controlled such that the next page is shown by upward operation and the previous page is shown by downward operation.

In the present embodiment, pages can be turned by operating any of the object layer area but the operable area may be limited. For example, the upper half or lower half of the display may be defined as an area for controlling object layer pages. In this case, the area for not controlling object layer pages may be defined as an area for scrolling contents.

In the present embodiment, an example has been described in which contents are outputted from the content storage portion 101, an object layer is outputted from the object arrangement portion 104, and the client terminal B120 displays the contents and the object layer together. The server 100 may superimpose the object layer on the contents in advance and send them to the client terminal B120 in the form of a single image. In this case, the object layer pages for the same content page are superimposed on the same contents and made into an image. This is effective when the client terminals are information terminals with poor specs.

In the present embodiment, it has been described that when combining a content page and an object layer with each other on the client terminal B120, the content page is displayed below the object layer and the object layer is superimposed on the content page. However, the object layer may be below the content page. In this case, it is preferable that the contents are displayed transparently so that objects can be visually identified. Further, when the content page includes not only a text layer but also a background layer (the paper part of a paper book), the object layer may be displayed between these layers. By highlighting the background, text can be highlighted without changing its original color.

In the present embodiment, an object layer may be provided in the form of an image. Since contents below the object layer have to be readable when being displayed, it is preferable to assign a transparent color to part of the object layer without any object. Further, the object layer may be displayed semi-transparently to such an extent that objects can be visually identified.

In the present embodiment, it has been described that the object layer is superimposed on the contents. However, the display modes may be switched by user operation or instruction to show contents only. Whether to display the object layer or not may be switched using an input device attached to the client terminal. Further, contents may be displayed alone by beginning the rendering of objects from page 2 of the object layer so as to create page 1 without any object, and superimposing page 1 on the contents. Further, contents alone may be displayed by assigning a page without any object to any page other than page 1 (e.g., the last page) and superimposing the page on the contents.

Further, by determining whether or not an object displayed on an object layer is referenced by a user based on whether or not the object layer is displayed on the client terminal, and determining the object as checked or unchecked based on whether the object has been displayed or not to manage the object checking history or to count the number of checked objects, a mechanism for notifying the user of unchecked objects as new objects may be provided. When a new object is added or the objects priorities change, the arrangement of the objects changes, so that the configuration of the objects to be arranged on a created object layer page also may change. Since there is no guarantee that objects are displayed on the same object layer page, it is desirable to manage the checking history based not on per object layer page but per object.

Further, when notifying the user of the number of posts, the number of unchecked posts, the number of recommended posts, etc., such notifications may be made based on the number of object layer pages and the number of object layer pages with unchecked objects. When making notifications based on the number of object layer pages, the object priorities may be set based on whether the objects have been checked or not. As a representation used in making notifications to users, a bar graph, a line graph or the like may be used for a visualization purpose in addition to showing the number of object layer pages in numeric value.

### Modified Example 1

### Compatibility with Double Page Spread

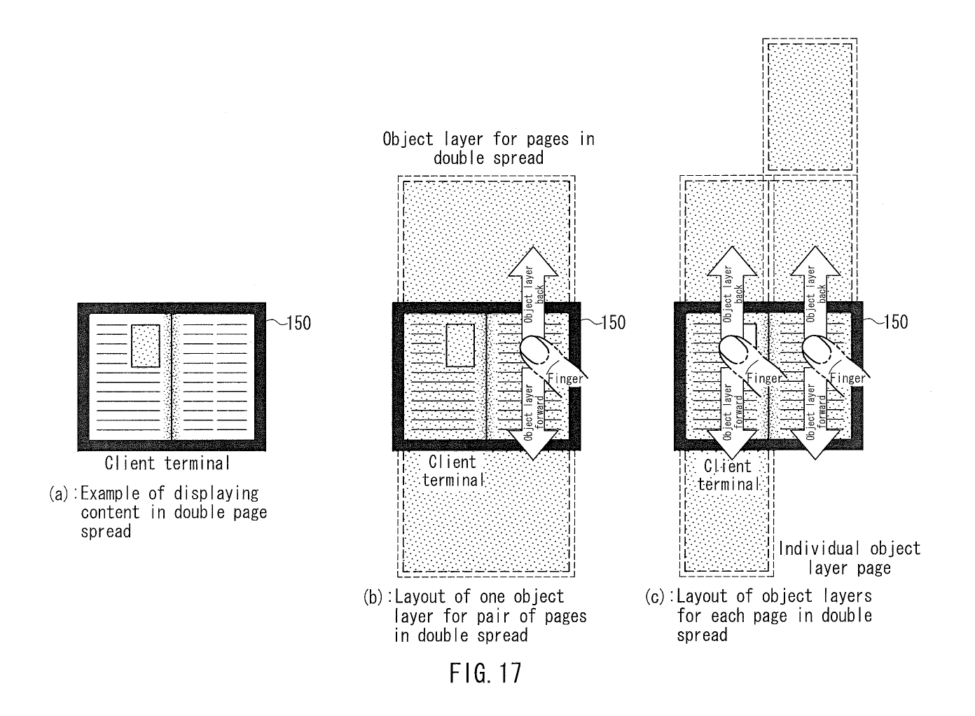

In the present embodiment, it has been described that one content page is displayed on a client terminal at a time. In this case, one object layer is provided for one content page. However, some client terminals display contents in double page spread. FIG. 17(a) shows an image in which a double page spread-compatible client terminal 150 displays contents in double page spread. It is assumed that pages are separated at the center and are displayed on the left and right sides. In this case, one object layer may be provided for the two spread content pages. FIG. 17(b) shows an arrangement in which one object layer is provided for the two spread pages. Since one object layer entirely covers the both spread pages, the configuration is the same as that used in displaying one content page. There is no problem with this configuration when contents are made exclusively for double page spread. However, when the display modes can be switched between a single page mode and a double page spread mode or the display modes vary from one client terminal to another, it is difficult to deal with this problem.

Therefore, different object layers may be provided for each page as in FIG. 17(c) in the case of double page spread. In this case, two object layers may be provided on the display to control each object layer page independently.

### Modified Example 2

### Object Arrangement Portion being Provided on Client Side

In the present embodiment, the configuration in which the server 100 includes the object arrangement portion 104 has been described. Further, the object arrangement portion 104 determines whether objects overlap one another and outputs an object layer including two or more pages. And the client terminal B120 is configured only to switch pages when displaying the object layer. The functions of the object arrangement portion 104 may be partially or entirely imparted to the client terminals.

When imparting the entire functions of the object arrangement portion 104 to the client terminals, data sent from the server 100 to the client terminal B120 is the object data outputted from the object storage portion 103 in the configuration of FIG. 9.

In this case, the object data can include information on the display position on contents (e.g., coordinate information). Thus, the function of the object arrangement portion can be carried out at the client terminal side.

The server 100 can be configured to send to the client terminals contents (main contents), objects (subcontents) associated with the contents, and information on the arrangement of the objects (e.g., coordinate information). In this case, the information on the arrangement of the objects is information indicating positions on the object layer (display layer) associated with each content page (display unit) at which the objects (subcontents) should be arranged.

The object data may be in vector data format or bitmap format representing the shapes of the objects, etc., for example. Further, the object data can include, for example, image and text information.

In this case, the object arrangement portion 104 receives from the object storage portion 103 data concerning objects, and the object arrangement portion 104 in the client terminal B120 creates an object layer in accordance with the operation flow shown in FIG. 12. However, at step S1207 of FIG. 12, the data is not sent to a terminal but is displayed on the display of the client terminal B120.

Therefore, in this modified example, the client terminal manages the object layer (display layer) associated with each page (unit of display) of contents (main contents). Further, on the basis of information on the arrangement of objects (subcontents) received from the server 100, the client terminal arranges the objects (subcontents) associated with the contents (main contents) on the object layer (display layer) managed by the terminal itself. And by displaying the object layer (display layer) on which the objects (subcontents) are arranged together with each content page (display unit) with which the object layer is associated, the client terminal displays the contents and the objects such that they are associated with each other.

As an example of partially imparting the functions of the object arrangement portion 104 to the client terminals, hypertext used in HTTP as an internet protocol is a representative example. In this scheme, the server only determines a layout and hand the layout information to a client terminal in an HTML format, and the client terminal renders a screen by interpreting HTML. In this case, although the client terminal creates an object layer as a screen, the server creates page breaks using tags.

In this case, such a representation can be achieved by replacing “rendering” at step S1204 of the operation flow of FIG. 12 with “inserting tags for breaks and arrangement”, for example.

Hypertext tags include those capable of specifying a range, such as a DIV tag representing a start (e.g., <DIV>) and an end (e.g. </DIV>). These tags may be utilize to designate page breaks (to be more precise, a range in a single page). The same thing can be said to Li and TABLE tags. At this time, information on which part of the display area should the objects be displayed is added to the tags as position (coordinate) information, and the display position is determined in accordance with the position information.

HTML and CSS may be used to represent the positions and shapes of the objects. Further, only objects may be made into images, or both the objects and contents may be combined and made into images.

Further, when using preexisting formats such as HTML and CSS, they may be combined with content information in the content storage portion and be sent to client terminals at once.

### Modified Example 3

### Definition of Object Overlap

In the operation flow of FIG. 12, object layer pages are switched based on the determination made at step S1206 as to whether or not objects overlap one another. However, pages can be switched based on other criteria.

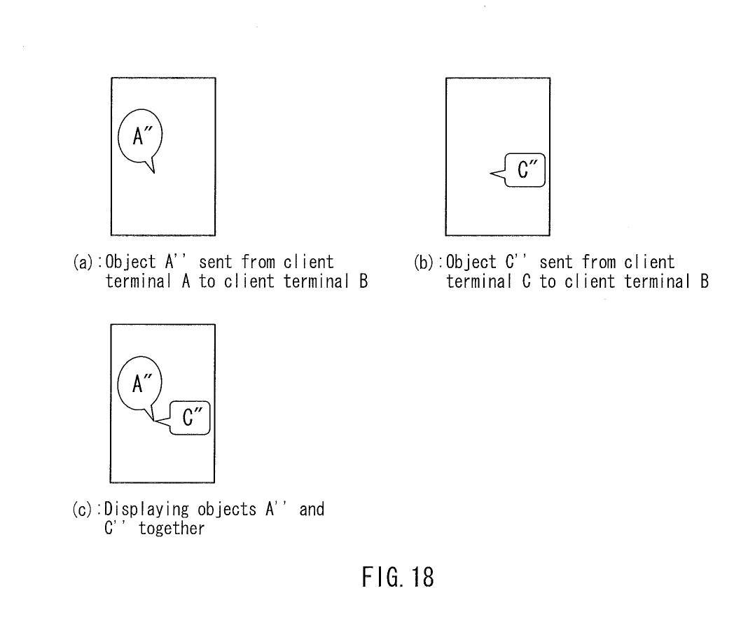

FIG. 18 shows an example thereof. FIG. 18(a) shows an object A″, which is sent from the client terminal A110 to the client terminal B120 in the state of FIG. 9. Further, FIG. 18(b) shows an object C″, which is sent from the client terminal C130 to the client terminal B120. FIG. 18(c) shows a state where the two objects are shown together. In FIG. 18(c), the objects do not overlap one another. However, the objects are in the form of a balloon and they are directed to the same position 180 on the contents. A new page may be created in this case, and the two objects may be arranged on different pages.

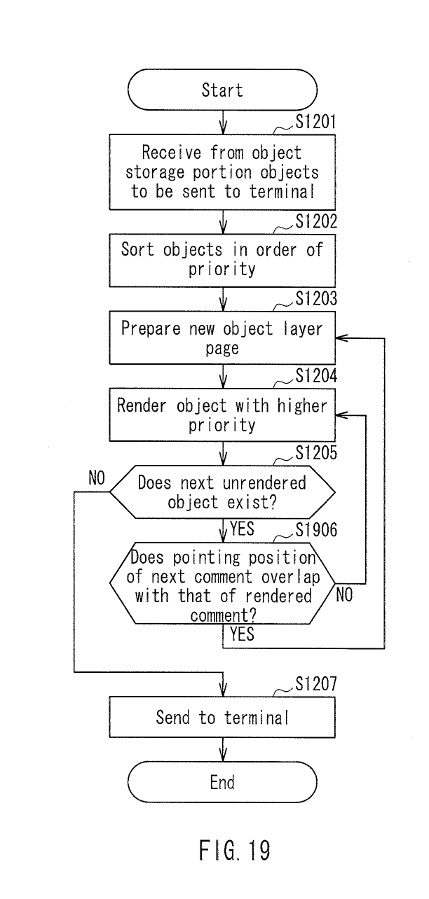

The operation flow in this case is shown in FIG. 19. In place of step S1206 of the flow of FIG. 12, the flow of FIG. 19 includes step S1906 at which whether or not the position to which one object is directed is the same as the position to which a rendered object is directed is determined (step S1906). As a result, the objects A″ and C″ are rendered on different object layer pages.

Even if objects do not completely overlap one another or they are not completely directed to the same position, the definition of overlap may be expanded to encompass a case where objects are in close proximity to each other when determining overlaps among objects. For example, if the distance between objects is equal to or smaller than a certain threshold, the objects may be determined as overlaping one another.

When an object is to be arranged in an area (such as an image) of contents to which a rendered object is directed, a determination may be made to arrange the objects on different object layer pages. In particular, if there is an object placed in close proximity to a content element (e.g., an image or text), object layer pages may be switched.

The maximum number of objects that can be arranged within one object layer page may be set even if there is no overlap among the objects. In this case, the objects are rendered while counting their number, and pages may be changed when the number of the rendered objects reaches the maximum number.

Instead of or in addition to the maximum number of objects that can be arranged within one object layer page, the maximum area may be set. In this case, the sum of the rendered object areas is determined, and the pages may be changed when the sum exceeds the maximum area.

The maximum number of objects or the maximum area of object layer page in which objects can be arranged may vary depending on the type of contents, the size of displayed text, and the display size of client terminal in which objects are displayed.

Whether or not objects overlap one another may be determined based on the distance between rectangles or shapes containing each object. For example, when the distance therebetween is equal to or smaller than a certain threshold, it may be determined that objects overlap one another.

### Embodiment 2

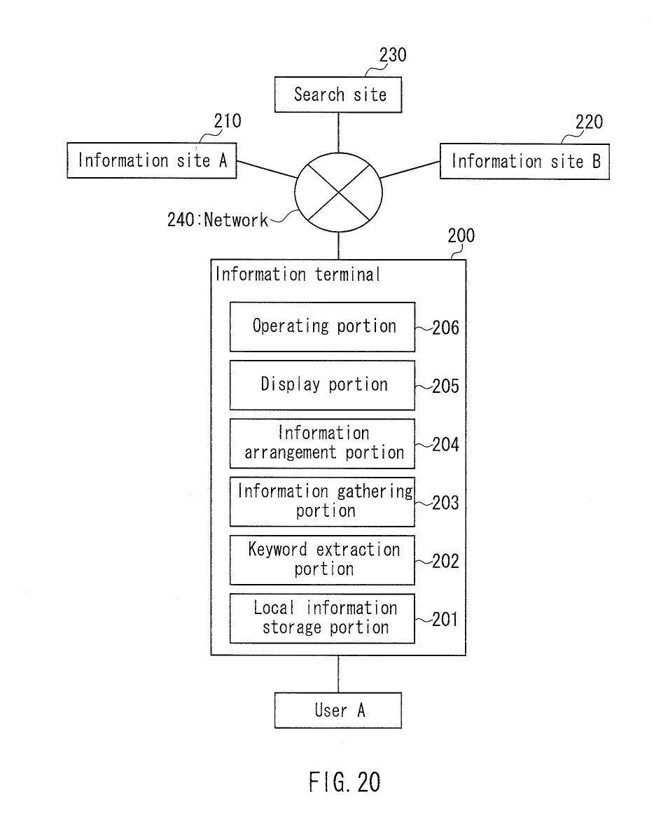

The present embodiment relates to information gathering using a network.

<FIG. 20: Description>

FIG. 20 is a diagram showing a hardware configuration according to the present embodiment. The system includes an information terminal 200, information sites A210 and B220, a search site 230, and a network 240. The information terminal 200 includes a local information storage portion 201, a keyword extraction portion 202, an information gathering portion 203, an information arrangement portion 204, a display portion 205 and an operating portion 206. The functions of the keyword extraction portion 202, the information gathering portion 203, the information arrangement portion 204, the display portion 205, and the operating portion 206 are partially or entirely embodied by a processor, such as a CPU, included in the information terminal 200 as a computing device executing predetermined programs. The functions of the local information storage portion 201 are partially or entirely embodied by a storage device, such as a disk or memory, included in the information terminal 200 as a computing device. As with the information terminal 200, the information sites 210 and 220 and the search site 230 also include a processor such as a CPU and a storage device such as a disk or memory.

It is assumed that the network 240 is the Internet. However, the network 240 may be another network such as an intranet or private line or may be a network composed of a plurality of types of networks.

The information sites A210 and B220 are sites that exist on network servers and offer an information distribution service. The type of service is not limited and may be selected from a wide range of services such as an SNS, a journal site, a web dictionary, a web encyclopedia, a news distribution site, and a weblog.

The search site 230 is a site on the network and information provided by other services can be searched thereon. In the real world, search sites made their debut on the Internet around 1995 and are used widely by the general public. When a phrase or sentence is entered, search sites display sites containing the phrase or sentence or sites offering similar information. Images also can be searched at some search sites by entering or specifying images. These search sites are constructed as follows. After gathering information on the network, the information is classified according to keywords and stored in a data base. And in response to a request from a user, the requested information is returned, using a search algorism, to the user. Since U.S. Pat. No. 6,285,999, for example, gives detailed descriptions as to searching, description thereof will not be repeated herein.

It is assumed that the targets of the information storage and search functions of the search site 230 include the information sites A210 and B220. The information terminal 200 uses the search function of the search site 230 to find and acquire information provided by each of the information sites A210 and B220.

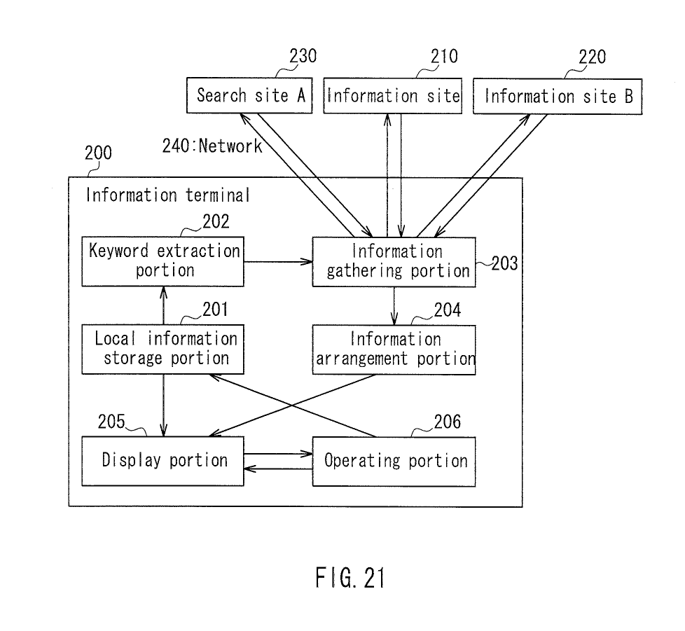

The information terminal 200 is a terminal owned by a user A. As in Embodiment 1, the information terminal 200 is a terminal capable of displaying information on the display and allowing the information to be controlled. The information terminal 200 is accessible to the network 240, and thus can use the search site 230 and the information sites A210 and B220.

<FIG. 21: Description>

FIG. 21 is a block diagram showing functions of the information terminal in the basic configuration of FIG. 20. Initial information installed in the information terminal 200 is stored in and managed by the local information storage portion 201. While contents are managed on the server 100 in Embodiment 1, it is assumed that in the present embodiment content information to be browsed by a user is stored in the information terminal 200. Since two or more pieces of information are stored in the local information storage portion 201, contents selected by user operation through displayed menus and icons are displayed. The input device used in making this selection is the operating portion 206, which is the same as the touch screen in Embodiment 1. In the present embodiment, it is referred to as the operating portion 206. Further, the selected contents (information) are displayed on the display portion 205, which is the same as the display portion in Embodiment 1. Local information on the contents that the user has determined to browse is sent to the keyword extraction portion 202. The keyword extraction portion 202 analyzes descriptions of the contents to be browsed, and extracts keywords as a result of the analysis. When the information includes text, such as in an electronic book, keywords related to words and attention grabbing sections are extracted. When the contents are video, a representative image, such as a person or scenery in the video, may be taken out. The extraction method is not limited and a semantic analysis, an image analysis, collective knowledge utilizing a network, or the like may be used.

Keywords extracted by the keyword extraction portion 202 are sent to the information gathering portion 203. The number of keywords to be sent at this time is not limited. The information gathering portion 203 searches for information related to the keywords using the search site 230. The search method may be one conforming to the method defined by the search site 230. In recent years, APIs (Application Program Interfaces) accessible from the web have been released by many search sites, so that it is rational to use an API.

In response to inquiries made by the information gathering portion 203, the search site 230 checks sites that provide the corresponding information. In the present embodiment, it is assumed that these sites are the information sites A210 and B220. As a consequence of receiving the results, the information gathering portion 203 now knows the sources providing the information. Thus, the information gathering portion 203 accesses the information sites A 210 and B220 again to retrieve the related information. Results are returned to the information gathering portion 203 from each of the information sites A210 and B220 in accordance with the requests.

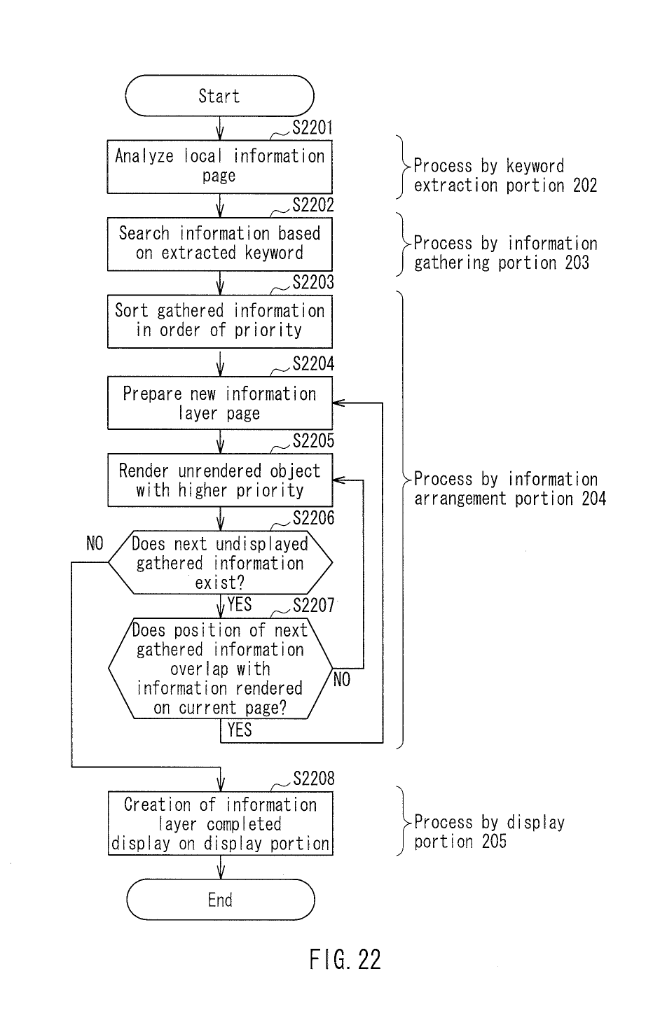

Thus, the information terminal 200 acquires information serving as additional information on the certain keywords. The acquired additional information is displayed on the local information displayed on the display portion 205. At that time, pieces of the additional information overlap one another as in Embodiment 1 in which the objects overlap one another. While comments are used as objects in Embodiment 1, it can be said that pieces of the additional information are objects in the present embodiment. The information arrangement portion 204 arranges the additional information. The information arrangement portion 204 arranges pieces of the information received from the information gathering portion 203 such that the pieces do not overlap one another and allow them to be displayed on the display portion 205.

<FIG. 22: Description>

FIG. 22 shows an operation flow of the information terminal 200 with particular emphasis on a process performed by the information arrangement portion 204. The keyword extraction portion 202 analyzes descriptions of local information to extract keywords (including image data) (step S2201). Based on the keywords extracted by the keyword extraction portion 202, the information gathering portion 203 uses the search site 230 and the information sites A210 and B220, all of which are connected to the network 240, to acquire information (step S2202). Based on the information gathered by the information gathering portion 203 (hereinafter referred to as the gathered information), the information arrangement portion 204 renders the gathered information on the local information. Prior to the rendering, the gathered information is sorted in the order of priority (step S2203). The gathered information is rendered on an information layer based on the sorted order. Here, as an example, it is assumed that a total of two pieces of information, one from the information site A210 and the other from the information site B220, are gathered for one keyword. This is not intended to limit the number of pieces of information in actual use.

The information layer is a layer for displaying the gathered information on local contents, and it is similar to the object layer in Embodiment 1. First, page 1 of the information layer is prepared (step S2204). Next, the unrendered pieces of gathered information with a higher priority is rendered on the information layer (step S2205). At this point, one of the two pieces of gathered information has been rendered on the information layer and the other is not rendered yet.

The next decision branching point is to check whether any unrendered piece of gathered information still remains (step S2206). Since one is not rendered yet, the process advances toward YES at this branching point. At the next step, whether the position at which the next gathered information is to be displayed overlaps with that of the rendered gathered information is determined (step S2207). In this example, it is assumed that the displaying positions overlap one another because the pieces of information were gathered based on the same keyword. Thus, the process advances to step S2204. If the displaying positions do not overlap one another, the information is rendered on the same information layer (determined as “YES” at step S2207).

At step S2204 for the second time, page 2 of the information layer is created. At the subsequent step S2205, the unrendered piece of gathered information is rendered on page 2 of the information layer. Since all of the pieces of gathered information have been rendered now, NO is selected at step S2206. The creation of the information layer is completed, and the local information together with the information layer are rendered on the display portion 205 (step S2208).

Since the relationship between the local information and the information layer is similar to that between the contents and the object layer in Embodiment 1, description of how the local information and the information layer are rendered will not be repeated.

As a result, the information terminal 200 can display the information associated with the local information without any overlap between the pieces of information.

### Modified Example

Although it has been described that the local information refers to information already retained in the information terminal 200, the local information may be one previously acquired through the network.

### Embodiment 3

The display method described in Patent Document 2 (U.S. Pat. No. 7,669,123) is a predominant method used in SNSs in recent years. In a SNS, it is necessary to display activities of a user together with those of his or her friends, and the number of friends can be several hundred or more in some cases. The invention of Patent Document 2 forms the basis of a timeline display where activities of one's friends are displayed vertically in order (chronological order).

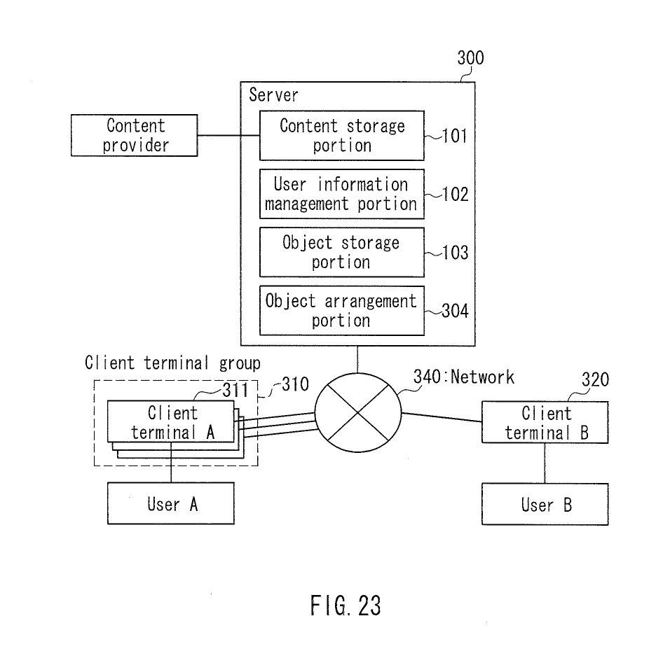

In the mechanism adopted in the configuration of Embodiment 1, first contents are opened and then comments (objects) associated with the contents are rendered. In view of actual service, it is necessary to have a mechanism for allowing a user to check his or her friends' comments at sight as in Patent Document 2, not content by content. Although the method of Patent Document 2 provides a mechanism for checking friends' comments at sight, it is not intended for communication on contents and thus cannot maintain information on content positions. The mechanism of the present embodiment is advantageous in this aspect.

<FIG. 23: Description>

FIG. 23 is a diagram showing a basic configuration according to the present embodiment. The system includes a server 300, a client terminal group 310, a client terminal B320, and a network 340.

It is assumed that the network 340 is the Internet. However, other network may be used and the connection method is not limited. Further, the server 300 is composed of the content storage portion 101, the user information management portion 102, the object storage portion 103, and the object arrangement portion 304. The content storage portion 101, the user information management portion 102, and the object storage portion 103 are the same as those in Embodiment 1 shown in FIG. 1.

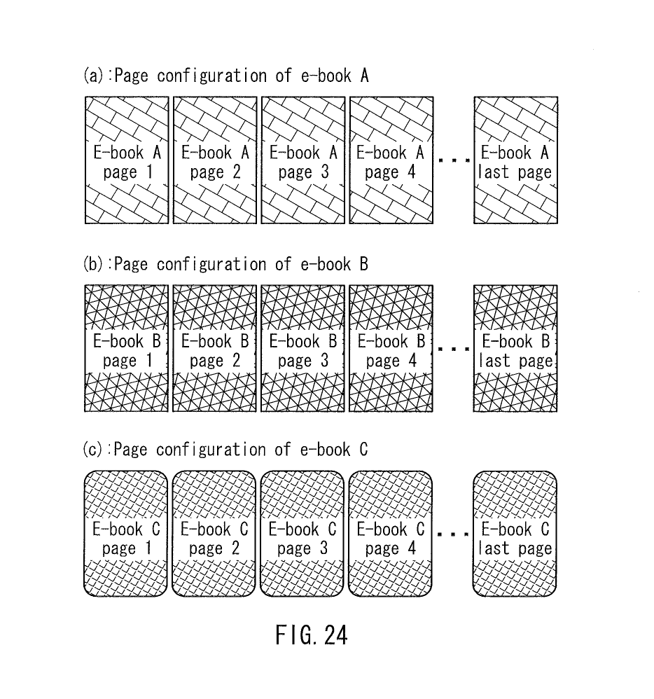

The client terminal group 310 is composed of an unspecified number of client terminals that use services provided by the server 300 through the network 340. The number of the client terminals is not limited. For example, since there are a great number of client terminals, they are collectively referred to as a group. Further, the terminals are owned by different owners and the owners form a user group. The number of the users is also not limited. Although the client terminal group 310 uses the server 300 based on operations by the user group, the location and the time of use of the respective terminals do not have to be the same. The users individually use the server 300 at their own timings through their client terminals. Further, one of the client terminals belonging to the client terminal group 310 will be referred to as a client terminal A311.

<FIG. 24: Description>

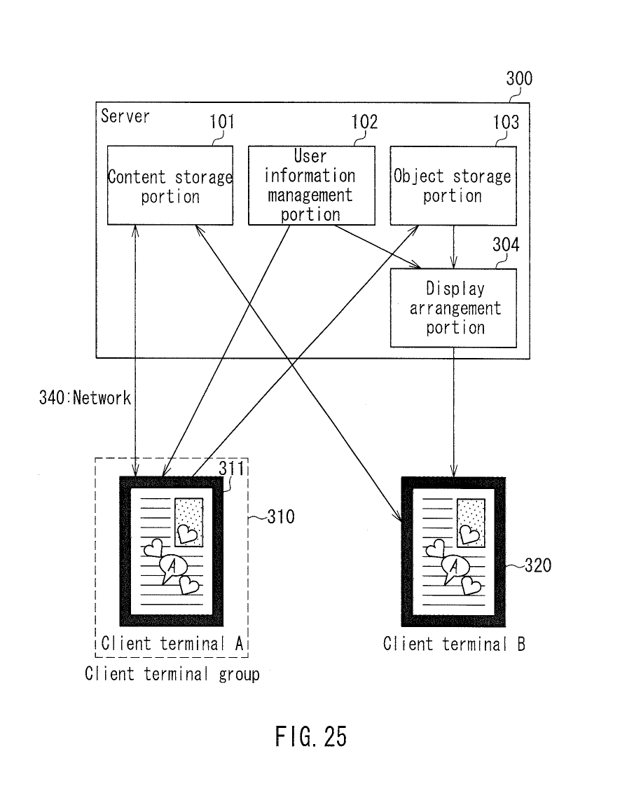

The contents used in the present embodiment are shown in FIG. 24. As the contents, electronic books will be taken as an example but the contents are not limited to electronic books. In particular, three types of contents are used this time. FIGS. 24(a), 24(b) and 24(c) show the configurations of electronic books A, B, and C, respectively. Each electronic book includes page 1 to the last page. Although electronic books basically include text in each page, only the titles of the books (electronic books A, B, C) and page numbers are shown in order to make it easier to distinguish one from another. Note that the page number of the last page can be determined as appropriate.

<FIG. 25: Description>

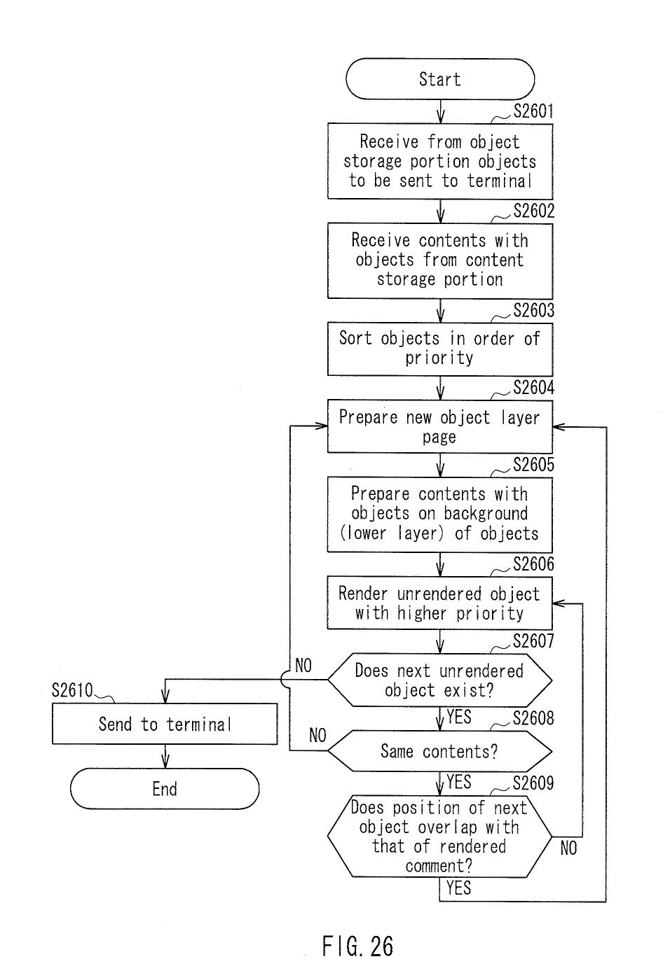

FIG. 25 shows a communication method according to the present embodiment through the server 300. The functions of the content management portion 101, the user information management portion 102, and the object storage portion 103 included in the server 300 already have been explained in Embodiment 1. In the present embodiment, there are many object senders and the client terminal B320 thus receives many objects. Further, the content data in the content storage portion 101 is not sent directly to the client terminal B320 but is sent to the display arrangement portion 304 of the server 300.

<FIG. 26: Description>

FIG. 26 shows an operation flow of the display arrangement portion 304. First, the display arrangement portion 304 receives from the object storage portion 103 objects to be sent to a terminal (step S2601). The objects received by the display arrangement portion 304 at this step are objects to be sent to the client terminal B320. Of the objects posted by the client terminal group 310, those that can be read by the user B of the client terminal B320 are the objects to be sent. In SNSs, each user reads comments posted by those who are related to the user through interests and commonalties, such as friends, followers, and members of the same group. Thus, the client terminal B320 receives comments posted by those related to the user B. The number of receivable comments is not limited. However, when the number of comments is way too many, comments that can be received at once may be limited only to unread comments or the latest few comments, for example.

Next, the display arrangement portion 304 receives content data from the content storage portion 101 (step S2602). The content data received by the display arrangement portion 304 at this step is content data associated with the objects received at step S2601. Content data to which no object is directed is not necessary. The content data received is the content data shown in FIG. 24. At this time, whether to receive the content data book by book or page by page can be determined as appropriate. Here, it is assumed that the display arrangement portion 304 receives the data page by page.

The objects received at step S2601 are sorted in display order based on their priorities (step S2603). The priorities can be set as appropriate. Since this step is the same as step S1202 in FIG. 12 explained in Embodiment 1, details and variations thereof will not be described.

Next, a new object layer page is prepared (step S2604). Since this step is also the same as step S1203 in FIG. 12 explained in Embodiment 1, detailed description thereof will not be repeated.

Next, a page containing contents to which an unrendered object with the highest priority is directed is laid out on the bottom of the object layer (step S2605).

Subsequently, the object is rendered (step S2606). Consequently, contents can be displayed within the object layer and the object can be rendered on the object layer.

Next, whether any unrendered object still remains is determined (step S2607). If no unrendered object remains, it means that all of the objects have been rendered. Thus, the resultant object layer is sent to the client terminal B320 (step S2610). Here, it is assumed that unrendered objects still remain.

Whether the object having the second highest priority is directed to the same content page as the object rendered at the previous step S2606 is determined (step S2608). If the object is directed to different contents or to a different page of the same contents, the process advances to step S2604 and a new object layer page is created.

If the object is directed to the same contents, whether the rendering position of the unrendered object with the highest priority overlaps with that of the rendered object is determined (step S2609). If the rendering positions do not overlap one another (determined as “NO” at step S2609), the unrendered object with the highest priority is rendered on the current object layer as in step S1204 in FIG. 12 explained in Embodiment 1 (step S2606). If the rendering positions overlap one another (determined as “YES” at step S2609), the process advances to step S2604 and a new object layer page is prepared.

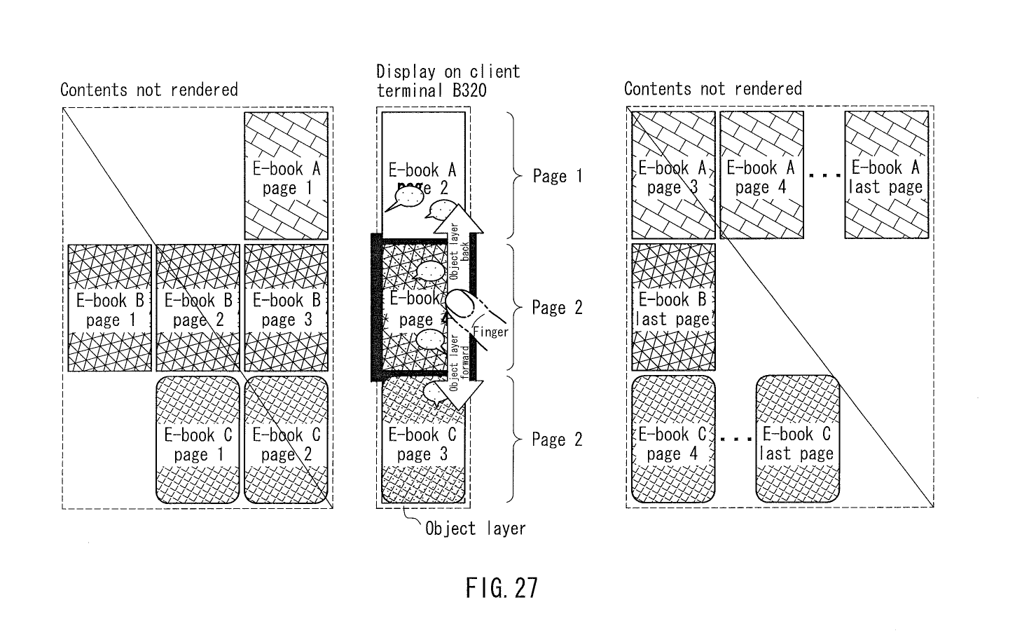

FIG. 27 shows an image where the object layer created by repeating the operation flow of FIG. 26 until all of the objects have been rendered is displayed on the client terminal B320.

<FIG. 27: Description>

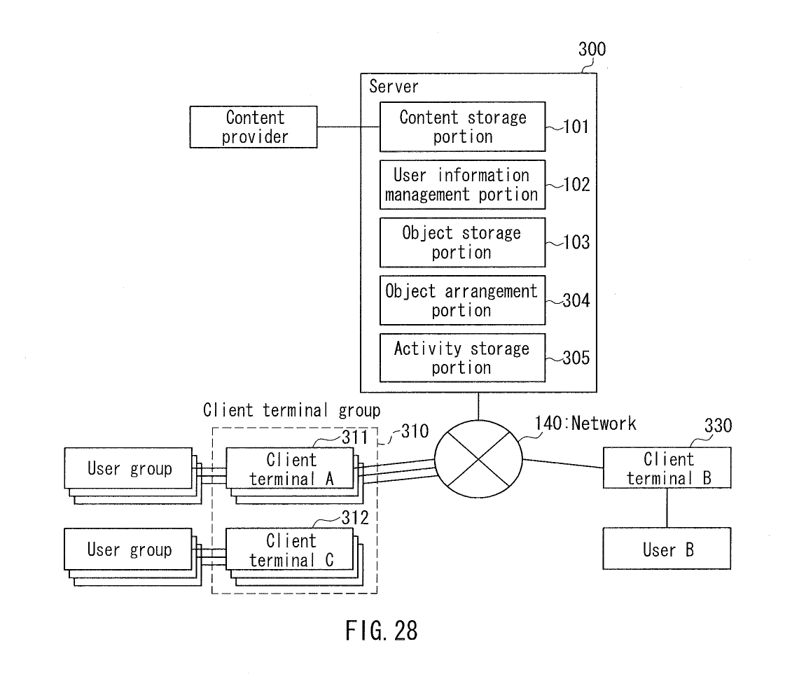

The object layer of FIG. 27 is composed of page 1 including page 2 of the electronic book A shown in FIG. 24(a) and objects, page 2 including page 4 of the electronic book B shown in FIG. 24(b) and objects, and page 3 including page 3 of the electronic book C shown in FIG. 24(c) and objects. In order to facilitate understanding, the previous and next pages of each page are also shown as unrendered contents. In this way, by extracting from the respective contents only content pages to which objects are assigned, and laying out the extract pages, only pages on which comments are given can be read without opening the electronic books individually.

<FIG. 28: Description>

Bearing in mind actual SNSs, all of the user comments do not necessarily relate to the contents. Rather, it is rare that comments exclusively related to the contents are posted. FIG. 28 shows basic blocks in the case where records on SNS activities irrelevant to the contents and comments about daily activities, notes and thoughts (hereinafter collectively referred to as activities) and comments related to the contents coexist.

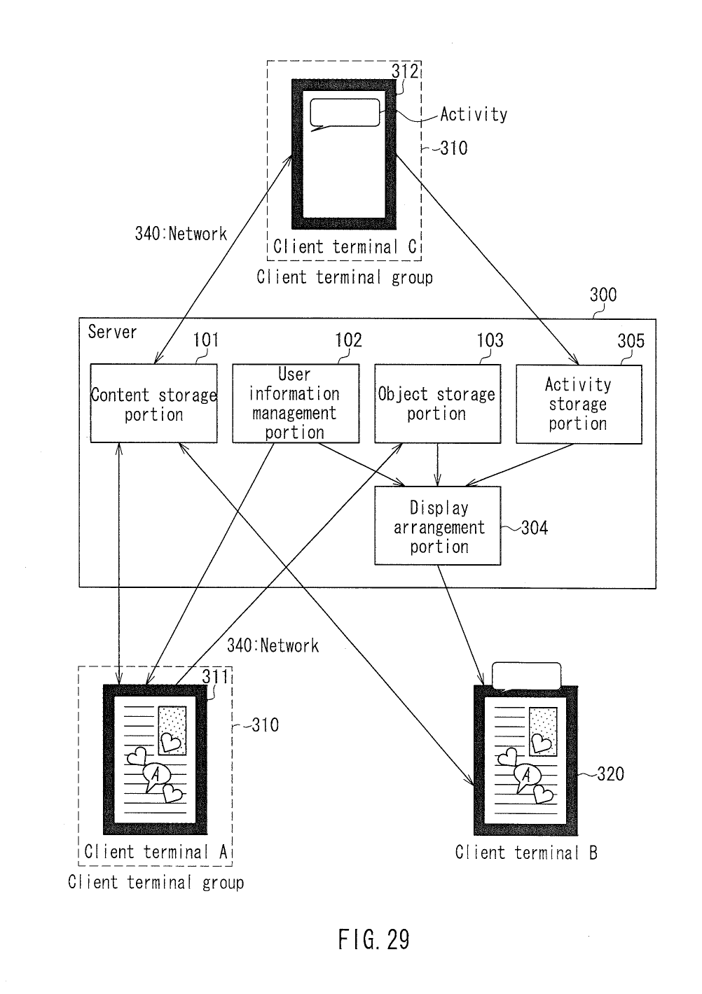

In FIG. 28, an activity storage portion 305 is added to the server 300. Further, as one of an indefinite number of client terminals belonging to the client terminal group 310, a client terminal C312 is newly defined. As with the terminals used in the previous embodiments, the client terminal A311 is used to post on the contents comments related to the contents. Further, the client terminal C312 posts activities irrelevant to the contents. The respective terminals are not exclusively for positing comments and activities, and the users of the respective terminals coincidentally made different types of posts.

<FIG. 29: Description>

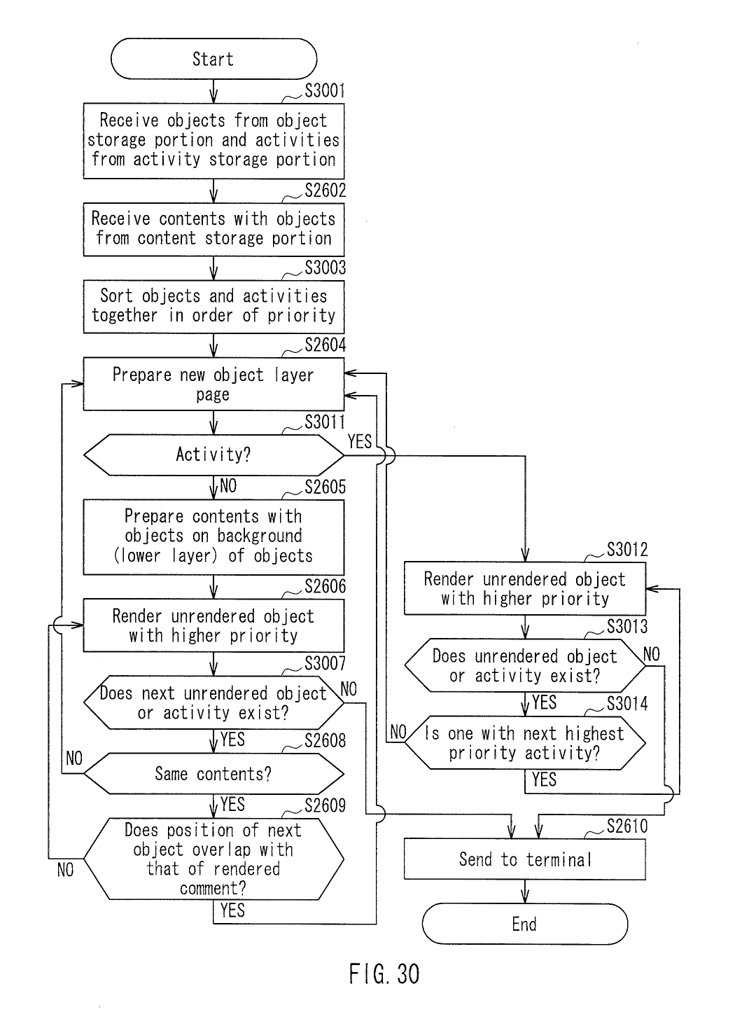

FIG. 29 shows a communication method where activities posted through the client terminal C312 and comments posted through the client terminal A 311 coexist. The difference from FIG. 25 is that activities are sent from the client terminal C312 to the server 300. Further, the server 300 receives the activities through the activity storage portion 305. Further, when sending the activities to the client terminal B320, the activities are sent from the activity storage portion 305 to the display arrangement portion 304.

<FIG. 30: Description>

FIG. 30 shows an operation flow of the display arrangement portion 304. Since FIG. 30 is a modified version of FIG. 26, FIG. 30 will be described with particular emphasis on the differences. First, the display arrangement portion 304 receives objects from the object storage portion 103 and activities from the activity storage portion 305 at the same time (step S3001). The activities received by the display arrangement portion 304 are activities to be sent to the client terminal B320, and are of those related to the user B, such as friends, or those in whome the user B is interested from the user group.

After receiving the contents related to the objects at step S2602, both the objects and the activities are sorted together in order of priority (step S3003). The way to set the priorities is in conformance with step S1202 in FIG. 12 explained in Embodiment 1. Although it is noted that the objects and the activities are sorted together, they do not have be sorted together if different priorities are to be given to them on purpose. The objects may be arranged after finished arranging all of the activities.

After preparing a new object layer page at step S2604, whether the one with the highest priority is an activity is determined (step S3011). When the one with the highest priority is an object, NO is selected and the process advances to step S2605 to render the object. The rendering of the object is substantially the same as that in FIG. 26. However, since it is necessary to render not only the objects but also the activities in this example, determining whether any unrendered object still remains at step S2607 is changed to whether all of the objects and activities have been rendered is determined (step S3007).

If it is determined at step S3011 that the one with the highest priority is an activity, YES is selected and the activity is rendered. First, the unrendered activity with the highest priority is rendered (step S3002). When rendering the activity, the process does not pass through step S2605. Thus, no content is rendered. This is because activities are irrelevant to the content layout screen.

After the rendering, whether any unrendered objects and activities still remain is determined (step S3013). Step S3013 is the same determination branching point as step S3007. When it is determined at step S3013 that all of the objects and the activities have been rendered, the rendering of the object layer is considered as being completed. Then, the process advances to step S2610 and the object layer is sent to the client terminal B320.

When it is determined at step S3013 as a determination branching point that unrendered objects and activities still remain, whether the one with the highest priority is an activity is determined (step S3014). When it is determined that the one with the highest priority is an activity, the process returns to step S3012 to render the activity as it can be rendered continuously. When it is determined that the one with the highest priority is an object, the process advances to step S2604 to prepare a new object layer.

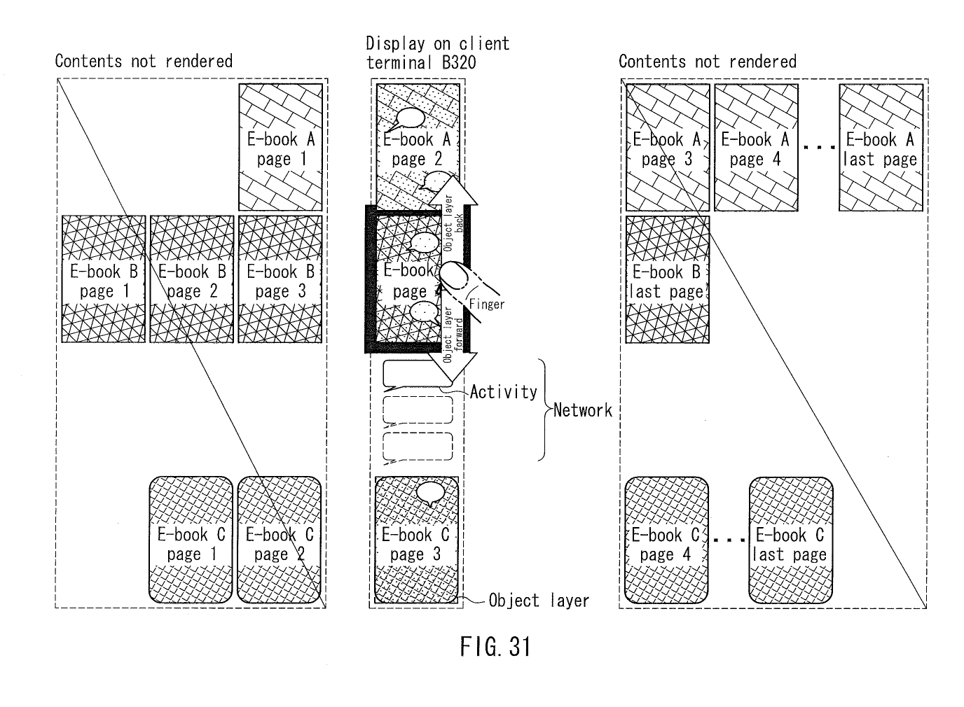

FIG. 31 shows an image where the object layer created by repeating the operation flow of FIG. 30 until all of the objects and the activities have been rendered is displayed on the client terminal B320.

<FIG. 31: Description>

FIG. 31 shows an image similar to that of FIG. 27. On the object layer, only contents pages on which objects are posted are rendered in order. At the same time, not the objects but the activities are also arranged in the same row. Thus, a user can read comments related to the contents as is on the contents. Further, the activities irrelevant to the contents can be displayed as is by the consistent operation system.

### Modified Example

When explaining Embodiment 1 with reference to FIG. 11(a), it has been described that two layers are not displayed at the same time. In the present embodiment, since contents and the object layer are combined with each other, the object layer does not have to be scrolled page by page.

In the above, the present embodiment has been described using the electronic books A to C. The displays can be switched on the basis of the type of contents (such as authors, publishers, titles) and users who posted comments (such as friends and family members).

### Embodiment 4

In the embodiments until now, a user interface has been described that allows a user to read objects in order by providing the object layer or information layer with the concept of page and scrolling the layer pages arranged in order of priority to change the display. In particular, as an example, a method in which pages are created in descending order of priority and operated downward is described. And when there are overlapping comments, comments are arranged in different layer pages to maintain their positional information with respect to contents.

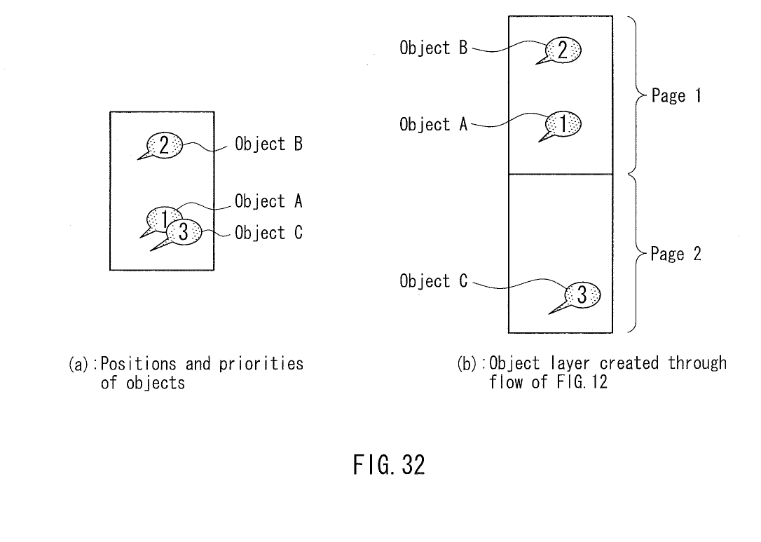

When this user interface is adopted, it can be perceived easily that comments are arranged in descending order of priority. However, priorities of objects within a single page are not taken into consideration. Therefore, a problem such as the one shown in FIG. 32 may occur, for example.

<FIG. 32: Description>

FIG. 32(a) shows the positions and priorities of objects used in the present embodiment. This time, three objects (objects A, B, and C) are used. The three objects are those posted on the same page of the same contents. The object A has the highest priority, then the object B, and then the object C. In order to facilitate understanding, numbers in the objects shown in FIG. 32 indicate the priorities. As the arrangement, the objects A and C are at overlapping positions and the object B is positioned above the objects A and C.

Since the objects A and C are situated at partially overlapping positions, it is difficult visually identify them. Therefore, in accordance with the process of FIG. 12 explained in Embodiment 1, the object layer is divided into pages and the respective objects are arranged on different pages. FIG. 32(b) shows an image of the object layer after rearranging each object. Since such a rule as “objects are arranged on the same page when they do not overlap one another and when they do, one object is arranged on the next page” is applied to the priorities, the objects A and B are rendered on page 1 of the object layer. Further, the object C that used to overlap with the object A is moved to and arranged on page 2 of the object layer.

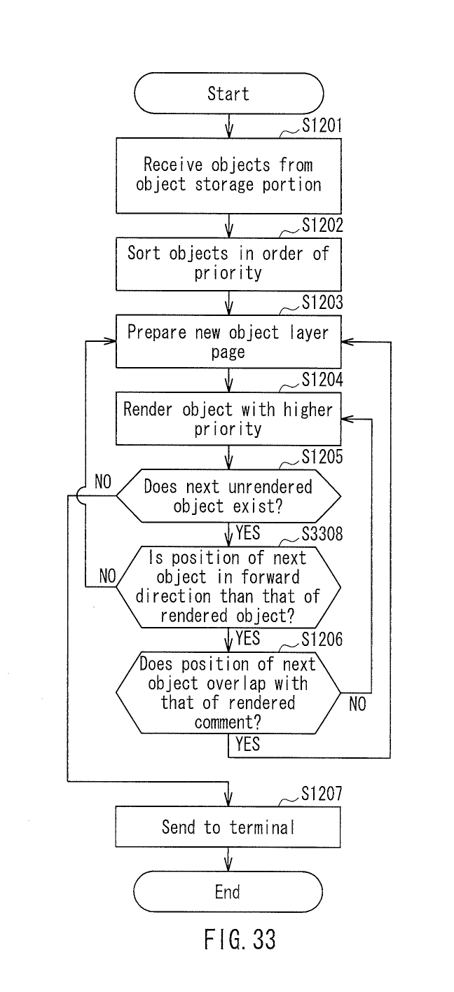

Here, the problem as mentioned above is arising in page 1. Since page 1 of the object layer has a higher priority than page 2, naturally, the pages are read in the direction from top to bottom. Between the two objects on page 1, the object A has a higher priority than the object B. However, since the object A is situated below the object B, a gap between the arrangement and how the user senses the objects arises, so that the object B appears as having a higher priority than the object A.

<FIG. 33: Description>

An operation flow for solving such a problem is shown in FIG. 33. Since the blocks and flow other than the object arrangement portion 104 are the same as those in FIG. 12 explained in Embodiment 1, only the operation flow of the object arrangement portion 104 of FIG. 12 is modified. In this way, FIG. 33 is a modified version of FIG. 12. Thus, only the changes made are described.

When any unrendered object remains at step S1205 after rendering an object with a higher priority, whether the next object to be rendered (one with the highest priority among unrendered objects) will be rendered in the forward direction related to the rendered object is determined (step S3308). The forward direction corresponds to the order in which object layer pages are displayed. In this example, contents are read in the direction from top to bottom. Thus, the forward direction is a “downward” direction. If the next object to be rendered will not be rendered in the forward direction (if the next object to be rendered will be rendered above the rendered object), step S1203 is implemented. If the next object to be rendered will be rendered in the forward direction (if the next object to be rendered will be rendered below the rendered object), the determination at step S1206 is implemented.

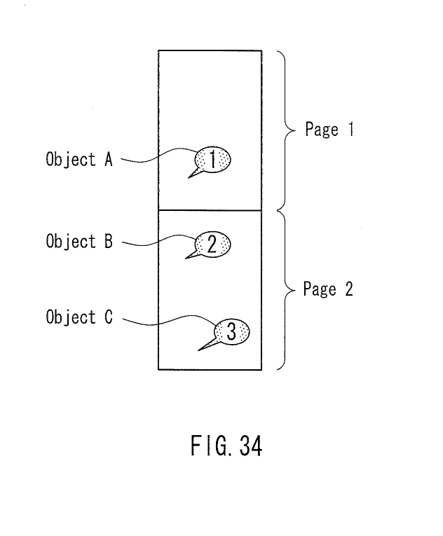

FIG. 34 shows the object layer created as a result of implementing the operation flow of FIG. 33. The arrangement of FIG. 34 is different from that of FIG. 32(b) in that the object B is positioned on not page 1 but page 2. This is because at the time of creating page 1 it is determined at step S1206 that the object B will be rendered in the opposite direction to the forward direction, i.e., it will be rendered above the rendered object A. Thus, page 2 of the object layer is created before rendering the object B, and the object B is rendered on page 2 of the object layer created. Since the object C is in the forward direction, i.e., it is below the object B and the rendering position of the object C does not overlap with that of the object B, it is rendered on page 2 as with the object B.

By this rendering method, the forward direction and the relationship between objects' rendering positions and priorities coincide with each other. Thus, a user can read the objects without feeling any discomfort.

### Modified Example

In the present embodiment, objects are displayed in descending order of priority so that the forward direction is a downward direction. However, objects may be displayed in ascending order of priority. At this time, the forward direction may be an upward direction and this does not fix the relationship between the priority and the display order.

### Embodiment 5

In the above, examples of applying the present invention to SNSs and information gathering has been described. The present invention also can be applied into other fields. For example, the present invention can be used when displaying a plurality of subcontents (objects) on main contents.

As an example, in the field of weather forecasting, a map may be displayed as main contents and the movements of clouds per unit time may be displayed on the map as subcontents. In this case, for example, object layer pages are created at every unit time, and clouds per unit time are displayed as objects associated with the map. As a result, movements of clouds per unit time can be recognized on the map with ease. Note that the objects are not limited to clouds, and may indicate information on rain, wind, lightning, pollen, or the like.

Further, in the field of car navigation systems, a map may be displayed as main contents and information on pay-by-the-hour parking lots may be displayed on the map as subcontents, as an example. In this case, object layer pages are created for parking fee, the maximum parking fee, the maximum parking time, vacancies of parking lots, parking lot management companies, etc., and information on corresponding parking lots (e.g., logo mark) is displayed as objects associated with the map. As a result, it is possible to find a parking lot on the map with ease. As a criterion for displaying parking lots, any of the above mentioned criteria may be selected.

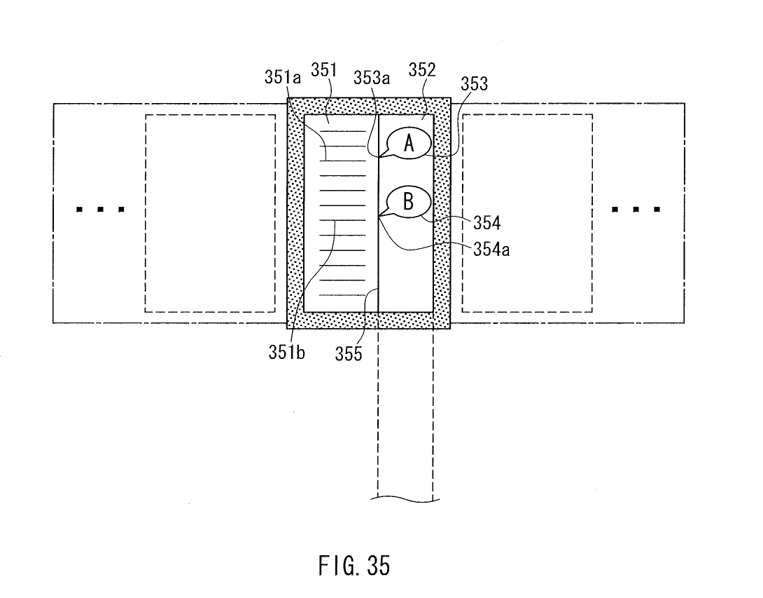

Further, in the above, examples of superimposing the object layer on contents are described. However, the contents and the object layer may be displayed separately. For example, as shown in FIG. 35, an object layer 352 may be displayed adjacent to contents 351 and each of objects 353 and 354 may be arranged on the object layer 352.

In this case, each of the objects 353 and 354 are arranged on the object layer 352 such that they are each associated with positions in the contents 351. For example, the object 353 is arranged such that a pointing position 353a of the balloon is associated with third line 351a of the contents 351. Further, the object 354 is arranged such that a pointing position 354a of the balloon is associated with seventh line 351b of the contents 351. Consequently, the contents and the comments (objects) can be visually identified separately.

Objects may be associated with any position in the contents. For example, a position in the contents with which an object is associated may be a coordinate position on the contents, a position on the contents at which an image is displayed, or a coordinate position on a line 355 displayed between the content 351 and the object layer 352. Further, when the line 355 indicates a time base, the objects and/or the contents may be associated with time indicated by the time base.

In FIG. 35, the content 351 and the object layer 352 are adjacent to each other but are displayed separately on the left side and the right side of the display screen, respectively. The manner in which they are separated may be determined as appropriate. For example, the contents 351 and the object layer 352 may be displayed separately on the upper side and the lower side of the display screen, respectively.

<Finally>

In the embodiments, it has been described that the server sends information on the object layer to the client terminals and the client terminals superimpose the object layer on the contents. However, this configuration does not limit the roles of the server and the client terminals. The opposite configuration to the configuration explained in the embodiments is that the server sends to the client terminals objects only and the client terminals create the object layer. Between these two opposite configurations, a variety of intermediate configurations of the roles of the server and the client terminals may exist.

In the embodiments, it has been described that objects (subcontents) may be inputted text, decorated images as in the prior art document, photos and videos. However, the types of objects are not limited to these. For example, dynamic objects that cause reproduction of video or audio with a click may be used. Further, for example, a link that brings a connection to a certain web site with a click may also be used.

The embodiments and their modified examples described above can be used in combination as needed. The embodiments combined are also within the scope of the present invention.

The content display system, the object display system, the object display server and the object display terminal according to the present invention are useful in making details of communication easily identifiable with simple operations and achieving smooth communication by displaying contents to be referenced and the details of communication together and expanding the display area of the details of communication, when having communication using contents through a network.

followings are examples of embodiments of the invention.

One embodiment of a content display system includes a client terminal for displaying contents and a server for managing the contents. The server manages a display layer associated with each page of main contents. The server creates a new page of the display layer based on predetermined rules and arranges on the new page of the display layer subcontents associated with the main contents. The server sends to the client terminal the main contents and the display layer on which the subcontents are arranged. The client terminal displays the display layer on which the subcontents are arranged together with each page of the main contents with which the display layer is associated to associate the main contents and the subcontents with each other.

One embodiment of a content display system includes a client terminal for displaying contents and a server for managing the contents. The server sends to the client terminal main contents, subcontents associated with the main contents and information on the arrangement of the subcontents. The client terminal manages a display layer associated with each page of the main contents. The client terminal creates a new page of the display layer based on predetermined rules and arranges on the new page of the display layer the subcontents associated with the main contents based on the information on the arrangement of the subcontents. The client terminal displays the display layer on which the subcontents are arranged together with each page of the main contents with which the display layer is associated to associate the main contents and the subcontents with each other.

In the content display system, when the subcontents associated with the display layer overlap one another on the display layer, the server may create a new different page of the display layer and arrange some of the subcontents on the new different page of the display layer.

In the content display system, wherein when the subcontents associated with the display layer overlap one another on the display layer, the client terminal may create a new different page of the display layer and arrange some of the subcontents on the new different page of the display layer.

In the content display system, wherein the server determines priorities of the subcontents used in displaying the subcontents on the display layer, and determines where to arrange the subcontents associated with the display layer on the display layer based on the determined priorities.

In the content display system, the client terminal may determine priorities of the subcontents used in displaying the subcontents on the display layer, and determine where to arrange the subcontents associated with the display layer on the display layer based on the determined priorities.

In the content display system, the server may determine relations between the main contents and the subcontents, and determine where to arrange the subcontents associated with the display layer on the display layer based on the determined relations.

In the content display system, the client terminal may determine relations between the main contents and the subcontents, and determine where to arrange the subcontents associated with the display layer on the display layer based on the determined relations.

In the content display system, a plurality of the display layers may be managed for each page of the main contents, and the client terminal may select the display layer to be displayed with the main contents, and display, among the subcontents associated with the main contents, the subcontents associated with the selected display layer.

In the content display system, when displaying the display layer and the main contents, the client terminal may superimposes the display layer on the main contents.

In the content display system, the client terminal may display the display layer adjacent to the main contents.

In the content display system, the subcontents may include at least an image or text.

In the content display system, the main contents may be an electronic book, and each page of the main contents is each display page of the electronic book, for example.

In the content display system, the client terminal may further include a content control portion for controlling the main contents, and a display layer control portion for controlling the display layer. A direction in which the content control portion is operated is different from a direction in which the display layer control portion is operated.

In the content display system, the client terminal may further include a content control portion for controlling the main contents, and a display layer control portion for controlling the display layer. A direction in which the content control portion is operated is orthogonal to a direction in which the display layer control portion is operated.

In the content display system, the client terminal may further include a content control portion for controlling the main contents, and a display layer control portion for controlling the display layer. A direction in which the content control portion is operated is the same as a direction in which the display layer control portion is operated, and an area for controlling the main contents is different from an area for controlling the display layer.

In the content display system, a vertical width of each page of the display layer may coincide with that of each page of the main contents.

In the content display system, a horizontal width of each page of the display layer may coincide with that of each page of the main contents.

In the content display system, the subcontents may be information extracted based on a keyword included in the main contents.

In the content display system, the subcontents may be activities of a user browsing the main contents and another user having a relation with the user in a social networking service.

In the content display system, the subcontents may be arranged on the display layer such that the subcontents are aligned in order of priority in a positive direction, where the positive direction is a direction in which the main contents are read.

One embodiment of a server for managing contents is the server forming a content display system with a client terminal for displaying the contents. the server manages a display layer associated with each page of main contents. The server creates a new page of the display layer based on predetermined rules and arranges on the new page of the display layer subcontents associated with the display layer. The server sends to the client terminal the main contents and the display layer on which the subcontents are arranged.

One embodiment of a non-transitory recording medium storing a program for implementing a server for managing contents using a computer. The server forms a content display system with a client terminal for displaying the contents. The program causes the computer to execute: managing a display layer associated with each page of main contents; creating a new page of the display layer based on predetermined rules and arranging on the new page of the display layer subcontents associated with the display layer; and sending to the client terminal the main contents and the display layer on which the subcontents are arranged.

One embodiment of a client terminal for displaying contents forms a content display system with a server for managing the contents. When the server manages a display layer associated with each page of main contents, the server creates a new page of the display layer based on predetermined rules and arranges on the new page of the display layer subcontents associated with the main contents, and sends to the client terminal the main contents and the display layer on which the subcontents are arranged. The client terminal displays the display layer on which the subcontents are arranged together with each page of the main contents with which the display layer is associated to associate the main contents and the subcontents with each other.

One embodiment of a non-transitory recording medium stores a program for implementing a client terminal for displaying contents using a computer. The client terminal forms a content display system with a server for managing the contents. When the server manages a display layer associated with each page of main contents, the server creates a new page of the display layer based on predetermined rules and arranges on the new page of the display layer subcontents associated with the main contents, and sends to the client terminal the main contents and the display layer on which the subcontents are arranged. The program causes the computer to execute displaying the display layer on which the subcontents are arranged together with each page of the main contents with which the display layer is associated to associate the main contents and the subcontents with each other.

One embodiment of a client terminal for displaying contents forms a content display system with a server for managing the contents. The client terminal manages a display layer associated with each page of the main contents. The client terminal creates a new page of the display layer based on predetermined rules and arranges on the new page of the display layer subcontents associated with the main contents based on information on the arrangement of the subcontents. The client terminal displays the display layer on which the subcontents are arranged together with each page of the main contents with which the display layer is associated to associate the main contents and the subcontents with each other.

One embodiment of a non-transitory recording medium stores a program for implementing a client terminal for displaying contents using a computer. The client terminal forms a content display system with a server for managing the contents. The program causes the computer to execute: managing a display layer associated with each page of the main contents; creating a new page of the display layer based on predetermined rules and arranging on the new page of the display layer subcontents associated with the main contents based on information on the arrangement of the subcontents; and displaying the display layer on which the subcontents are arranged together with each page of the main contents with which the display layer is associated to associate the main contents and the subcontents with each other.

One embodiment of a content display device manages a display layer associated with each page of the main contents. The content display device creates a new page of the display layer based on predetermined rules and arranges on the new page of the display layer subcontents associated with the main contents. The content display device displays the display layer on which the subcontents are arranged together with each page of the main contents with which the display layer is associated to associate the main contents and the subcontents with each other.

In the content display device, the content display device may manage a plurality of the display layers for each page of the main contents. The content display device may select the display layer to be displayed with the main contents, and display, among the subcontents associated with the main contents, the subcontents associated with the selected display layer.

In the content display device, when the subcontents associated with the display layer overlap one another on the display layer, the content display device may create a new different page of the display layer and arrange some of the subcontents on the new different page of the display layer.

One embodiment of a non-transitory recording medium stores a program for implementing a content display device using a computer. The program causes the computer to execute: managing a display layer associated with each page of the main contents; creating a new page of the display layer based on predetermined rules and arranging on the new page of the display layer subcontents associated with the main contents; and displaying the display layer on which the subcontents are arranged together with each page of the main contents with which the display layer is associated to associate the main contents and the subcontents with each other.

One embodiment of a content display method uses a client terminal for displaying contents and a server for managing the contents. In this method, the server manages a display layer associated with each page of main contents. The server creates a new page of the display layer based on predetermined rules and arranges on the new page of the display layer subcontents associated with the main contents. The server sends to the client terminal the main contents and the display layer on which the subcontents are arranged. The client terminal displays the display layer on which the subcontents are arranged together with each page of the main contents with which the display layer is associated to associate the main contents and the subcontents with each other.

One embodiment of a content display method uses a client terminal for displaying contents and a server for managing the contents. In this method, the server sends to the client terminal main contents, subcontents associated with the main contents, and information on the arrangement of the subcontents. The client terminal manages a display layer associated with each page of the main contents. The client terminal creates a new page of the display layer based on predetermined rules and arranges on the new page of the display layer the subcontents associated with the main contents based on the information on the arrangement of the subcontents. The client terminal displays the display layer on which the subcontents are arranged together with each page of the main contents with which the display layer is associated to associate the main contents and the subcontents with each other.

One embodiment of a content display method including: managing a display layer associated with each page of main contents; creating a new page of the display layer based on predetermined rules and arranging on the new page of the display layer subcontents associated with the main contents; and displaying the display layer on which the subcontents are arranged together with each page of the main contents with which the display layer is associated to associate the main contents and the subcontents with each other.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A content display system, wherein,
the content display system manages a display layer associated with each page of main contents,
the content display system creates a new page of the display layer based on predetermined rules and arranges on the new page of the display layer subcontents associated with the main contents, and
the display system allows a device to display the display layer on which the subcontents are arranged together with each page of the main contents with which the display layer is associated to associate the main contents and the subcontents with each other.

2. A content display system according to claim 1, comprising a client terminal including the display device for displaying contents and a server for managing the contents,
wherein the server manages the display layer associated with each page of the main contents,
the server creates the new page of the display layer and arranges on the new page of the display layer subcontents associated with the main contents,
the server sends to the client terminal the main contents and the display layer on which the subcontents are arranged, and
the client terminal displays the display layer on which the subcontents are arranged together with each page of the main contents.

3. A content display system according to claim 1, comprising a client terminal including the display device for displaying contents and a server for managing the contents,
wherein the server sends to the client terminal main contents, subcontents associated with the main contents and information on the arrangement of the subcontents,
the client terminal manages a display layer associated with each page of the main contents,
the client terminal creates the new page of the display layer and arranges on the new page of the display layer the subcontents associated with the main contents based on the information on the arrangement of the subcontents, and
the client terminal displays the display layer on which the subcontents are arranged together with each page of the main contents.

4. The content display system according to claim 1, wherein when the subcontents associated with the display layer overlap one another on the display layer, the content display system creates a new different page of the display layer and arranges some of the subcontents on the new different page of the display layer.

5. The content display system according to claim 1, wherein the content display system determines priorities of the subcontents used in displaying the subcontents on the display layer, and determines where to arrange the subcontents associated with the display layer on the display layer based on the determined priorities.

6. The content display system according to claim 1, wherein the content display system determines relations between the main contents and the subcontents, and determines where to arrange the subcontents associated with the display layer on the display layer based on the determined relations.

7. The content display system according to claim 1, wherein a plurality of the display layers are managed for each page of the main contents, and
the content display system selects the display layer to be displayed with the main contents, and allow the display device to display, among the subcontents associated with the main contents, the subcontents associated with the selected display layer.

8. The content display system according to claim 1, wherein the content display system allows the display device to display the display layer and the main contents so as to superimpose the display layer on the main contents.

9. The content display system according to claim 1, wherein the content display system allows the display device to display the display layer adjacent to the main contents.

10. The content display system according to claim 1, wherein the subcontents includes at least an image or text.

11. The content display system according to claim 1, wherein the main contents are an electronic book, and each page of the main contents is each display page of the electronic book.

12. The content display system according to claim 1, wherein the display device further includes a content control portion for controlling the main contents, and a display layer control portion for controlling the display layer, and
a direction in which the content control portion is operated is different from a direction in which the display layer control portion is operated.

13. The content display system according to claim 1, wherein the display device further includes a content control portion for controlling the main contents, and a display layer control portion for controlling the display layer, and
a direction in which the content control portion is operated is orthogonal to a direction in which the display layer control portion is operated.

14. The content display system according to claim 1, wherein the display device further includes a content control portion for controlling the main contents, and a display layer control portion for controlling the display layer,
a direction in which the content control portion is operated is the same as a direction in which the display layer control portion is operated, and an area for controlling the main contents is different from an area for controlling the display layer.

15. The content display system according to claim 1, wherein a vertical width of each page of the display layer coincides with that of each page of the main contents.

16. The content display system according to claim 1, wherein a horizontal width of each page of the display layer coincides with that of each page of the main contents.

17. The content display system according to claim 1, wherein the subcontents are information extracted based on a keyword included in the main contents.

18. The content display system according to claim 1, wherein the subcontents are activities of a user browsing the main contents and another user having a relation with the user in a social networking service.

19. The content display system according to claim 5, wherein the subcontents are arranged on the display layer such that the subcontents are aligned in order of the priority in a positive direction, where the positive direction is a direction in which the main contents are read.

20. A non-transitory recording medium storing a program for implementing a content display system using a computer, the program causing the computer to execute:
managing a display layer associated with each page of the main contents;
creating a new page of the display layer based on predetermined rules and arranging on the new page of the display layer subcontents associated with the main contents; and
allowing a display device to display the display layer on which the subcontents are arranged together with each page of the main contents with which the display layer is associated to associate the main contents and the subcontents with each other.

21. A content display method, comprising:
managing a display layer associated with each page of main contents;
creating a new page of the display layer based on predetermined rules and arranging on the new page of the display layer subcontents associated with the main contents; and
allowing a display device to display the display layer on which the subcontents are arranged together with each page of the main contents with which the display layer is associated to associate the main contents and the subcontents with each other.
